(19) United States
(12) Patent Application Publication
(10) Pub. No.: US 2025/0038369 A1
(43) Pub. Date: Jan. 30, 2025

(54) BATTERY AND METHOD OF MANUFACTURING SAME

(71) Applicant: Panasonic Intellectual Property Management Co., Ltd., Osaka (JP)

(72) Inventors: KOICHI HIRANO, Osaka (JP); KAZUYOSHI HONDA, Osaka (JP); KAZUHIRO MORIOKA, Osaka (JP); AKIRA KAWASE, Osaka (JP)

(21) Appl. No.: 18/905,140

(22) Filed: Oct. 2, 2024

Related U.S. Application Data
(63) Continuation of application No. PCT/JP2022/040947, filed on Nov. 2, 2022.

(30) Foreign Application Priority Data
Apr. 20, 2022 (JP) 2022-069505

(51) Int. Cl. H01M 50/533; H01M 10/0585; H01M 50/105; H01M 50/178; H01M 50/46; H01M 50/534; H01M 50/54

(52) U.S. Cl. CPC H01M 50/533; H01M 10/0585; H01M 50/105; H01M 50/178; H01M 50/46; H01M 50/534; H01M 50/54

(57) ABSTRACT

A battery of the present disclosure includes: a power-generation element including a plurality of laminated battery cells connected electrically in parallel, each battery cell including an electrode layer, a counter-electrode layer, and a solid electrolyte layer; and a first connection member connected to a side surface of the power-generation element, and the first connection member includes a first metal layer having a first surface facing the side surface, a first insulating layer located on the first surface, and first conductive vias passing through the first insulating layer and electrically connecting the first metal layer and the electrode layers.

### BACKGROUND

### 1. Technical Field

The present disclosure relates to a battery and a method of manufacturing the same.

### 2. Description of the Related Art

Batteries including laminated current collectors and active substance layers have been known.

For example, Japanese Unexamined Patent Application Publications Nos. 2020-13729 and 2008-198492 disclose battery laminates including laminated unit batteries each including a positive-electrode current collector layer, a positive-electrode active substance layer, an ion-conductive inorganic substance layer, a negative-electrode active substance layer, and a negative-electrode current collector layer laminated in this order.

### SUMMARY

Increasing the capacity density of a battery requires the effective volume contributing to power generation to be improved. To achieve this, it is effective to extend the electrodes from side surfaces of the battery cells. For example, Japanese Unexamined Patent Application Publications Nos. 2020-13729 and 2008-198492 disclose batteries in which the electrodes are extended from side surfaces of the battery laminate. However, the batteries disclosed in Japanese Unexamined Patent Application Publications Nos. 2020-13729 and 2008-198492 have gaps between end portions of the laminated battery cells and hence have a problem that the capacity density of the batteries is low.

One non-limiting and exemplary embodiment provides a battery with a high capacity density and a simple manufacturing method for the battery.

In one general aspect, the techniques disclosed here feature a battery including: a power-generation element including a plurality of laminated battery cells connected electrically in parallel, each battery cell including an electrode layer, a counter-electrode layer, and a solid electrolyte layer; and a first connection member connected to a side surface of the power-generation element, in which the first connection member includes a first metal layer having a first surface facing the side surface, a first insulating layer located on the first surface, and one or more first conductive vias passing through the first insulating layer and electrically connecting the first metal layer and the electrode layers.

The present disclosure provides a battery with a high capacity density and a simple manufacturing method for the battery.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view of a battery according to Embodiment 1;

FIG. 2 is a perspective view of the battery according to Embodiment 1;

FIG. 3A is a cross-sectional view for explaining a step of a method of manufacturing the battery according to Embodiment 1;

FIG. 3B is a cross-sectional view for explaining a step of the method of manufacturing the battery according to Embodiment 1;

FIG. 3C is a cross-sectional view for explaining a step of the method of manufacturing the battery according to Embodiment 1;

FIG. 3D is a cross-sectional view for explaining a step of the method of manufacturing the battery according to Embodiment 1;

FIG. 3E is a cross-sectional view for explaining a step of the method of manufacturing the battery according to Embodiment 1;

FIG. 4A is a cross-sectional view for explaining a step of a method of manufacturing a battery according to Embodiment 2;

FIG. 4B is a cross-sectional view for explaining a step of the method of manufacturing the battery according to Embodiment 2;

FIG. 4C is a cross-sectional view for explaining a step of the method of manufacturing the battery according to Embodiment 2;

FIG. 4D is a cross-sectional view for explaining a step of the method of manufacturing the battery according to Embodiment 2;

FIG. 5 is a cross-sectional view of a battery according to Embodiment 3;

FIG. 6A is a cross-sectional view for explaining a step of a method of manufacturing the battery according to Embodiment 3;

FIG. 6B is a cross-sectional view for explaining a step of the method of manufacturing the battery according to Embodiment 3;

FIG. 6C is a cross-sectional view for explaining a step of the method of manufacturing the battery according to Embodiment 3;

FIG. 6D is a cross-sectional view for explaining a step of the method of manufacturing the battery according to Embodiment 3;

FIG. 6E is a cross-sectional view for explaining a step of the method of manufacturing the battery according to Embodiment 3;

FIG. 6F is a cross-sectional view for explaining a step of the method of manufacturing the battery according to Embodiment 3;

FIG. 7A is a cross-sectional view for explaining a step of a method of manufacturing a battery according to Embodiment 4;

FIG. 7B is a cross-sectional view for explaining a step of the method of manufacturing the battery according to Embodiment 4;

FIG. 8 is a cross-sectional view of a battery according to Embodiment 5;

FIG. 9 is a cross-sectional view of a battery according to Embodiment 6;

FIG. 10 is a cross-sectional view of a battery according to Embodiment 7;

FIG. 11 is a perspective view of the battery according to Embodiment 7;

FIG. 12 is a cross-sectional view of a battery according to Embodiment 8;

FIG. 13 is a perspective view of a battery according to Embodiment 9;

FIG. 14A is a cross-sectional view of the battery according to Embodiment 9;

FIG. 14B is a cross-sectional view of the battery according to Embodiment 9;

FIG. 15 is a perspective view of a battery according to Embodiment 10;

FIG. 16 is a side view of a connection member according to Embodiment 10;

FIG. 17A is a cross-sectional view of the battery according to Embodiment 10; and

FIG. 17B is a cross-sectional view of the battery according to Embodiment 10.

### DETAILED DESCRIPTIONS

### (Overview of Present Disclosure)

The following shows a plurality of examples of the battery according to the present disclosure.

A battery according to a first aspect of the present disclosure includes:
a power-generation element including a plurality of laminated battery cells connected electrically in parallel, each battery cell including an electrode layer, a counter-electrode layer, and a solid electrolyte layer; and
a first connection member connected to a side surface of the power-generation element, and
the first connection member includes
   a first metal layer having a first surface facing the side surface,
   a first insulating layer located on the first surface, and
   one or more first conductive vias passing through the first insulating layer and electrically connecting the first metal layer and the electrode layers.

Since this configuration enables the electrodes to be extended from the side surface of the power-generation element by using the first conductive via, the volume of the portion for extension can be small. This increases the volume of the portion effective for power generation relative to the entire battery and makes it possible to provide a battery with a high capacity density. In addition, since the first insulating layer and the first metal layer cover the side surface of the power-generation element, it is possible to provide a robust battery with high reliability.

As a second aspect of the present disclosure, for example, the battery according to the first aspect may have a configuration in which the battery further includes
a second connection member connected to the side surface, and
the second connection member includes
   a second metal layer having a second surface facing the side surface,
   a second insulating layer located on the second surface, and
   one or more second conductive vias passing through the second insulating layer and electrically connecting the second metal layer and the counter-electrode layers.

Since this configuration enables both the electrodes and the counter electrodes to be extended from the side surface of the power-generation element by using the first conductive via and the second conductive via, the volume of the portion for extension can be smaller. This makes it possible to further improve the capacity density of the battery. In addition, since the second insulating layer and the second metal layer cover the side surface of the power-generation element, it is possible to provide a robust battery with high reliability.

As a third aspect of the present disclosure, for example, the battery according to the second aspect may have a configuration in which,
the side surface includes a first side surface and a second side surface different from the first side surface,
the first connection member is connected to the first side surface,
the first surface faces the first side surface,
the second connection member is connected to the second side surface, and
the second surface faces the second side surface.

Since the first side surface and the second side surface are different surfaces in this configuration, the first connection member and the second connection member can be located away from each other. Specifically, the distance between the first conductive via and the first metal layer for extending the electrodes and the second conductive via and the second metal layer for extending the counter electrodes can be long. This makes it possible to prevent the occurrence of a short circuit and provide a battery with high reliability.

As a fourth aspect of the present disclosure, for example, in the battery according to the third aspect,
the first side surface and the second side surface may be flat.

Since the electrodes are extended from the flat surfaces, the volume of the portion for extension can be smaller. This makes it possible to further increase the capacity density of the battery.

As a fifth aspect of the present disclosure, for example, in the battery according to the first aspect,
the first connection member may further include
   a second metal layer having a second surface facing the side surface and located on the first insulating layer so as to be aligned with the first metal layer,
   one or more second conductive vias passing through the first insulating layer and electrically connecting the second metal layer and the counter-electrode layers, and
   a third insulating layer having a third surface,
a surface of the first metal layer opposite to the first surface may be in contact with the third surface, and
a surface of the second metal layer opposite to the second surface may be in contact with the third surface.

This configuration enables the first metal layer for extending the electrodes and the second metal layer for extending the counter electrodes to be provided on the one connection member by sharing the third insulating layer. Hence, the volume of the portion for extension can be smaller, and it is possible to further increase the capacity density of the battery. In addition, since the third insulating layer covers the side surface of the power-generation element, it is possible to increase the robustness of the battery.

As a sixth aspect of the present disclosure, for example, in the battery according to any one of the first to fourth aspects, the first connection member may further include a third insulating layer in contact with a surface of the first metal layer opposite to the first surface.

Since the third insulating layer covers the side surface of the power-generation element in this configuration, it is possible to increase the robustness of the battery.

As a seventh aspect of the present disclosure, for example, in the battery according to any one of the first to fourth aspects, the first metal layer may be a metal foil.

Since the metal foil with high electrical conductivity is used, it is possible to achieve low resistance in the electrode extension portion.

As an eighth aspect of the present disclosure, for example, the battery according to any one of the first to seventh aspects may further include one or more conductive pads located on the side surface and between the electrode layers and the one or more first conductive vias.

This configuration makes it possible to increase the reliability of the connection between the first conductive via and the electrode layers.

As a ninth aspect of the present disclosure, for example, in the battery according to the eighth aspect, the pads may contain a resin and conductive particles dispersed in the resin.

This configuration enables the pad to be connected with high adhesiveness to the electrode layers exposed on the side surface of the power-generation element. Hence, it is easy to extend the electrodes from the side surface of the power-generation element.

As a tenth aspect of the present disclosure, for example, in the battery according to any one of the first to ninth aspects, the first metal layer may be connected to a main surface of the power-generation element.

Since this increases the contact area between the first metal layer and an electrode layer or an electrode current collector layer located on the main surface of the power-generation element, it is possible to achieve a lower resistance.

As an eleventh aspect of the present disclosure, for example, in the battery according to any one of the first to ninth aspects, the first metal layer may extend in a direction away from the side surface.

In this configuration, the extension portion of the first metal layer can be used for electrical connection to another device.

As a twelfth aspect of the present disclosure, for example, the battery according to the eleventh aspect may further include an outer case containing the power-generation element, and the first metal layer may extend to the outside of the outer case.

Since the power-generation element is enclosed in the outer case in this configuration, it is possible to increase the reliability of the battery. In addition, since the extension portion of the first metal layer can be used for electrical connection, another member for connection is not necessary, and it is possible to increase the capacity density of the battery.

As a thirteenth aspect of the present disclosure, for example, in the battery according to any one of the first to twelfth aspects, the one or more first conductive vias may contain a resin and conductive particles dispersed in the resin.

This configuration enables the first conductive via to be connected with high adhesiveness to the electrode layers exposed on the side surface of the power-generation element. This makes it easy to extend the electrodes from the side surface of the power-generation element.

The following shows a plurality of examples of the method of manufacturing a battery according to the present disclosure.

A method of manufacturing a battery, according to a fourteenth aspect of the present disclosure includes
connecting a connection member to a side surface of a power-generation element including a plurality of laminated battery cells connected electrically in parallel, each battery cell including an electrode layer, a counter-electrode layer, and a solid electrolyte layer,
the connection member includes
   a first insulating layer and
   one or more first conductive vias passing through the first insulating layer, and
in the connecting the connection member, the one or more first conductive vias and the electrode layers are electrically connected such that a first surface of a first metal layer faces the side surface, and that the first insulating layer is located between the side surface and the first surface.

Since the connection member prepared separately from the power-generation element is used in this method, the manufacturing steps of the battery are simplified. In the battery manufactured in this method, since the electrodes can be extended from the side surface of the power-generation element by using the first conductive via, the volume of the portion for extension can be small. This increases the volume of the portion effective for power generation relative to the entire battery and makes it easy to manufacture the battery with a high capacity density.

As a fifteenth aspect of the present disclosure, for example, the method of manufacturing a battery according to the fourteenth aspect may further include:
forming the first insulating layer on the first surface; and
forming the one or more first conductive vias such that the one or more first conductive vias are in contact with the first metal layer.

With this method, it is possible to form the connection member easily, separately from the power-generation element.

As a sixteenth aspect of the present disclosure, for example, the method of manufacturing a battery according to the fourteenth aspect may further include;

forming the first insulating layer; and

forming the one or more first conductive vias, and in the connecting the connection member, the first insulating layer in which the one or more first conductive vias are formed may be placed between the side surface and the first metal layer so as to be in contact with the side surface and the first metal layer, and the one or more first conductive vias may be electrically connected to the electrode layers.

Since the first metal layer is not on the first insulating layer in the step of forming the first conductive via, it is easy to form through holes in the first insulating layer.

As a seventeenth aspect of the present disclosure, for example, the method of manufacturing a battery according to any one of the fourteenth to sixteenth aspects may further include forming the first metal layer on a main surface of a third insulating layer.

Since the third insulating layer is used in this method, it is possible to manufacture a robust battery.

As an eighteenth aspect of the present disclosure, for example, the method of manufacturing a battery according to the seventeenth aspect may further include:
forming a second metal layer on the main surface of the third insulating layer at a position away from the first metal layer; and
forming one or more second conductive vias passing through the first insulating layer and being in contact with the second metal layer, and
in the connecting the connection member, in addition, the one or more second conductive vias may be electrically connected to the counter-electrode layers.

In this method, the third insulating layer can be shared by the first metal layer and the first conductive via for extending the electrodes and the second metal layer and the second conductive via for extending the counter electrodes. This simplifies the step of forming the connection member.

As a nineteenth aspect of the present disclosure, for example, the method of manufacturing a battery according to any one of the fourteenth to eighteenth aspects may further include
forming one or more conductive pads connected to the electrode layers, on the side surface of the power-generation element, and
in the connecting the connection member, the one or more first conductive vias may be brought into contact with the one or more pads.

This method improves the adhesiveness of the connection between the first conductive via and the electrode layers and makes it possible to manufacture a battery with high reliability.

As a twentieth aspect of the present disclosure, for example, in the method of manufacturing a battery according to any one of the fourteenth to nineteenth aspects, in the connecting the connection member, at least part of the first metal layer may protrude outward relative to a main surface of the power-generation element, and the method of manufacturing a battery may further include bending the part of the first metal layer protruding outward relative to the main surface of the power-generation element to bring the first metal layer into contact with the main surface of the power-generation element.

This makes it easy to reduce the resistance of the connection between the electrode extension portion and the power-generation element.

In the following, embodiments of the present disclosure will be described specifically with reference to the drawings.

All of the following embodiments are for showing general or specific examples. Numerical values, shapes, materials, constituents, the arrangement positions and methods of connection of constituents, steps, the order of steps, and the like in the following embodiments are examples, and these are not intended to limit the present disclosure. Of the constituents in the description of the following embodiments, the constituent not stated in the independent claims are optional.

Each figure shows a schematic diagram, which is not necessarily illustrated to be precise. Hence, for example, the scale or the like in each figure is not necessarily consistent. In each figure, substantially the same constituents are denoted by the same symbols, and repetitive description is omitted or simplified.

In this specification, the terms indicating the relationship between elements such as “parallel” and “orthogonal” and the terms indicating the shapes of elements such as “rectangle” and “rectangular parallelepiped”, and the ranges of numerical values are not expressions in only a strict sense but expressions that express substantially the same or similar ranges, for example, ranges including differences of several percent or so.

In the present specification and the drawings, the x-axis, the y-axis, and the z-axis correspond to the three axes of a three-dimensional Cartesian coordinate system. In the case in which the shape of a power-generation element of a battery in plan view is rectangular, the x-axis and the y-axis correspond to the directions parallel to a first side and a second side, orthogonal to the first side, of the rectangle. The z-axis corresponds to the laminating direction of a plurality of battery cells included in a power-generation element.

In this specification, the “laminating direction” corresponds to the direction of the normal line of the main surfaces of current collectors and active substance layers. In this specification, “plan view” denotes viewing in the direction perpendicular to the main surfaces of a power-generation element, unless otherwise noted such as in the case in which the term is used alone. Note that in the case in which a phrase “plan view of a certain surface” such as “plan view of a first side surface” is stated, the certain surface refers to the “certain surface” viewed from the front.

In this specification, the terms “upper” and “lower” are not intended to indicate the upward direction (the vertically upward direction) and the downward direction (the vertically downward direction) in the absolute spatial awareness but are used as terms defined by a relative positional relationship based on the laminating order of a laminated structure. The terms “upper” and “lower” are applied to not only the case in which two constituents located away from each other, and another constituent is present between the two constituent, but also the case in which two constituents are in close contact with each other. In the following description, the negative side of the z-axis is defined as “lower” or “on the lower side”, and the positive side of the z-axis is defined as “upper” or “on the upper side”.

In this specification, the ordinal numbers such as “first” and “second” do not denote the number or the order of constituents and are used for the purpose of avoiding confusion between the same kind of constituents and distinguishing between constituents, unless otherwise noted.

### Embodiment 1

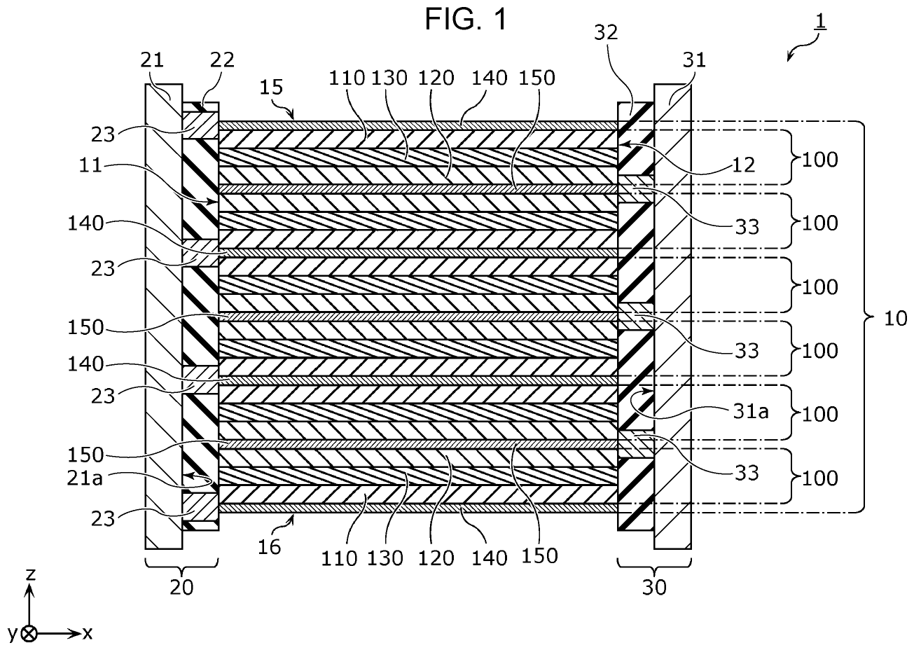

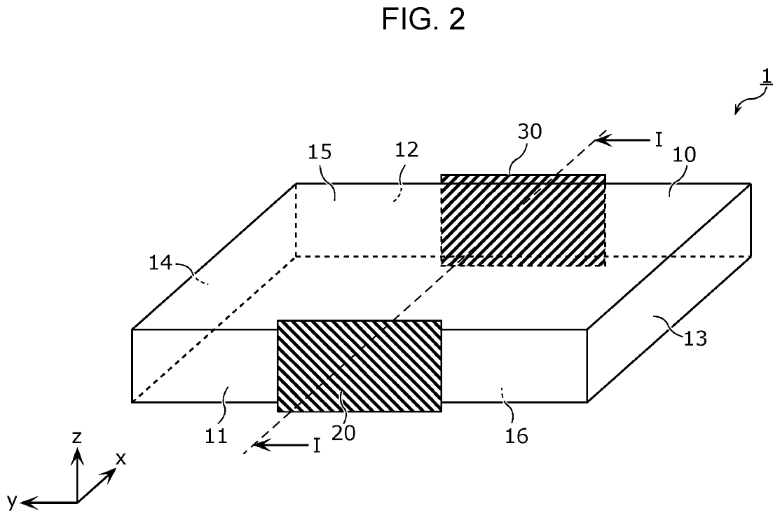

In the following, the configuration of a battery according to Embodiment 1 will be described with reference to FIGS. 1 and 2.

FIG. 1 is a cross-sectional view of a battery 1 according to the present embodiment. FIG. 1 illustrates the cross section taken along line I-I in FIG. 2. FIG. 2 is a perspective view of the battery 1 according to the present embodiment. As illustrated in FIGS. 1 and 2, the battery 1 according to the present embodiment includes a power-generation element 10, an electrode connection member 20, and a counter-electrode connection member 30. The battery 1 is, for example, an all-solid-state battery.

### [Power-Generation Element]

First, a specific configuration of the power-generation element 10 will be described.

As illustrated in FIG. 2, the power-generation element 10 has a flat rectangular parallelepiped shape. The word “flat” mentioned here denotes that the thickness (in other words, the length in the z-axis direction) is shorter than each side (in other words, the lengths in the x-axis direction and in the y-axis direction) or the maximum width of the main surfaces. The shape of the power-generation element 10 in plan view is not limited to a rectangle and may be another polygon such as a square, a hexagon, or an octagon, or a circular or elliptical shape.

As illustrated in FIGS. 1 and 2, the power-generation element 10 includes the main surfaces 15 and 16 and the side surfaces. The side surfaces include the four side surfaces 11, 12, 13, and 14. In the present embodiment, each of the side surfaces 11, 12, 13, and 14 and the main surfaces 15 and 16 is flat.

The side surface 11 is an example of a first side surface, and the electrode connection member 20 is connected to the side surface 11. The side surface 12 is an example of a second side surface, which differs from the first side surface, and the counter-electrode connection member 30 is connected to the side surface 12. The side surface 12 is opposite to the side surface 11. The side surfaces 11 and 12 are, for example, cut surfaces. The side surfaces 13 and 14 are opposed to each other, and each of the side surfaces 13 and 14 is orthogonal to the side surfaces 11 and 12.

The main surfaces 15 and 16 are opposed to each other, and each of the main surfaces 15 and 16 is orthogonal to the side surfaces 11, 12, 13, and 14. The main surface 15 is the uppermost surface of the power-generation element 10. The main surface 16 is the lowermost surface of the power-generation element 10.

As illustrated in FIG. 1, the power-generation element 10 includes a plurality of battery cells 100, a plurality of electrode current collector layers 140, and a plurality of counter-electrode current collector layers 150. Note that in the illustration in FIG. 1 and other cross-sectional views, the thickness of each layer is exaggerated to facilitate understanding of the layer structure of the power-generation element 10.

The battery cell 100 is a battery of a smallest configuration and is hence also referred to as a unit cell. The plurality of battery cells 100 are connected electrically in parallel and laminated. In the present embodiment, all of the battery cells 100 of the power-generation element 10 are connected electrically in parallel.

Each of the battery cells 100 includes an electrode layer 110, a counter-electrode layer 120, and a solid electrolyte layer 130. The solid electrolyte layer 130 is located between the electrode layer 110 and the counter-electrode layer 120.

With attention focused on two adjacent battery cells 100 of the plurality of battery cells 100, the laminating order of the layers included in each of the two battery cells is opposite. For example, in the battery cell 100 in the lowermost layer, the electrode layer 110, the solid electrolyte layer 130, and the counter-electrode layer 120 are laminated in this order from bottom to top. In contrast, in the second battery cell 100 from the bottom, the counter-electrode layer 120, the solid electrolyte layer 130, and the electrode layer 110 are laminated in this order from bottom to top. In other words, in these two battery cells 100, the counter-electrode layers 120 of the two battery cells 100 face each other with a counter-electrode current collector layer 150 located in between.

The plurality of battery cells 100 are laminated such that the laminating order of the layers alternates for each battery cell. Hence, for example, in the second and third battery cells 100 from the bottom, the electrode layers 110 of the two battery cells 100 face each other with an electrode current collector layer 140 located in between. In this configuration, an electrode current collector layer 140 and a counter-electrode current collector layer 150 alternate in the z-axis direction.

In the present embodiment, the electrode layer 110 is, for example, a positive electrode layer, and the counter-electrode layer 120 is, for example, a negative electrode layer. The electrode current collector layer 140 is, for example, a positive-electrode current collector layer, and the counter-electrode current collector layer 150 is, for example, a negative-electrode current collector layer.

The electrode layer 110 is located between the electrode current collector layer 140 and the solid electrolyte layer 130. Note that another layer such as a conductive joining layer may be provided between the electrode layer 110 and the electrode current collector layer 140.

The electrode layer 110 is, for example, a positive-electrode active substance layer containing a positive electrode material such as a positive-electrode active substance. For the material of the positive-electrode active substance, various materials that metal ions such as lithium ions and magnesium ions can be detached from and inserted into can be used. For the positive-electrode active substance that lithium ions can be detached from and inserted into, for example, lithium-cobalt composite oxide (LCO), lithium-nickel composite oxide (LNO), lithium-manganese composite oxide (LMO), lithium-manganese-nickel composite oxide (LMNO), lithium-manganese-cobalt composite oxide (LMCO), lithium-nickel-cobalt composite oxide (LNCO), lithium-nickel-manganese-cobalt composite oxide (LNMCO), and lithium-nickel-cobalt-aluminum composite oxide (LNCAO) can be used.

The constituent material of the electrode layer 110 may include, for example, a solid electrolyte such as an inorganic solid electrolyte. Examples of inorganic solid electrolytes that can be used include a sulfide solid electrolyte and an oxide solid electrolyte. Examples of sulfide solid electrolytes that can be used include a mixture of lithium sulfide (Li₂S) and diphosphorus pentasulfide (P₂S₅). Examples of sulfide solid electrolytes that can be used include sulfides such as Li₂S—SiS₂, Li₂S—B₂S₃, and Li₂S—GeS₂, and these sulfides containing at least one selected from the group of Li₃N, LiCl, LiBr, Li₃PO₄, and Li₄SiO₄ as an additive can also be used.

Examples of oxide solid electrolytes that are used include Li₂La₃Zr₂O₁₂ (LLZ), Li_{1.3}Al_{0.3}Ti_{1.7}(PO₄)₃(LATP), and (La,Li)TiO₃(LLTO). The surface of the positive-electrode active substance may be coated with a solid electrolyte.

The constituent material of the electrode layer 110 may include, for example, at least one of a conductive material such as acetylene black, Ketjenblack (registered trademark), and carbon nanofiber, or a binder such as polyvinylidene fluoride.

The thickness of the electrode layer 110 is, for example, greater than or equal to 5 μm and less than or equal to 300 μm but is not limited to this range.

The counter-electrode layer 120 is located between the counter-electrode current collector layer 150 and the solid electrolyte layer 130. The counter-electrode layer 120 faces the electrode layer 110 with the solid electrolyte layer 130 interposed in between. Note that another layer such as a conductive joining layer may be provided between the counter-electrode layer 120 and the counter-electrode current collector layer 150.

The counter-electrode layer 120 is, for example, a negative-electrode active substance layer containing a negative-electrode active substance as an electrode material. For the negative-electrode active substance, various materials that ions such as lithium ions and magnesium ions can be detached from and inserted into can be used. As for the negative-electrode active substances that can be used for the constituent substances of the counter-electrode layer 120, examples of the negative-electrode active substances that lithium ions can be detached from and inserted into include a simple substance such as graphite, metallic lithium, or silicon, and a mixture of some of them, or lithium-titanium oxide (LTO).

For the constituent material of the counter-electrode layer 120, for example, a solid electrolyte such as an inorganic solid electrolyte can be used. Examples of inorganic solid electrolytes that can be used include the inorganic solid electrolytes shown as examples of the constituent material of the electrode layer 110.

The constituent material of the counter-electrode layer 120 may include, for example, at least one of a conductive material such as acetylene black, Ketjenblack, and carbon nanofiber, or a binder such as polyvinylidene fluoride.

The thickness of the counter-electrode layer 120 is, for example, greater than or equal to 5 μm and less than or equal to 300 μm but is not limited to this range.

The solid electrolyte layer 130 is located between the electrode layer 110 and the counter-electrode layer 120. The solid electrolyte layer 130 is in contact with both the electrode layer 110 and the counter-electrode layer 120.

The solid electrolyte layer 130 contains a solid electrolyte. Examples of solid electrolytes that can be used include an inorganic solid electrolyte. Examples of the inorganic solid electrolytes that can be used include the inorganic solid electrolytes shown as examples of the constituent material of the electrode layer 110.

Note that the solid electrolyte layer 130 may contain, in addition to an electrolyte material, a binder or the like such as polyvinylidene fluoride, for example.

The thickness of the solid electrolyte layer 130 is, for example, greater than or equal to 5 μm and less than or equal to 300 μm but is not limited to this range. The thickness of the solid electrolyte layer 130 may be, for example, greater than or equal to 5 μm and less than or equal to 100 μm.

A main surface of the electrode current collector layer 140 is in contact with an electrode layer 110. As for an electrode current collector layer 140 located between two battery cells 100, of the plurality of electrode current collector layers 140, each of the two main surfaces is in contact with an electrode layer 110. As for the electrode current collector layer 140 in the uppermost or lowermost layer, only one of the two main surfaces is in contact with an electrode layer 110. Specifically, the lower surface of the electrode current collector layer 140 in the uppermost layer is in contact with an electrode layer 110, and the upper surface of the electrode current collector layer 140 in the uppermost layer is the main surface 15 of the power-generation element 10. The upper surface of the electrode current collector layer 140 in the lowermost layer is in contact with an electrode layer 110, and the lower surface of the electrode current collector layer 140 in the lowermost layer is the main surface 16 of the power-generation element 10. Note that the electrode current collector layer 140 may include a current collector layer provided where the electrode current collector layer 140 is in contact with the electrode layer 110 and containing a conductive material.

A main surface of the counter-electrode current collector layer 150 is in contact with a counter-electrode layer 120. As for a counter-electrode current collector layer 150 located between two battery cells 100, of the plurality of counter-electrode current collector layers 150, each of the two main surfaces is in contact with a counter-electrode layer 120. Note that the counter-electrode current collector layer 150 may include a current collector layer provided where the counter-electrode current collector layer 150 is in contact with the counter-electrode layer 120 and containing a conductive material.

Each of the electrode current collector layer 140 and the counter-electrode current collector layer 150 is a conductive member having a foil shape, a plate shape, or a mesh shape. Each of the electrode current collector layer 140 and the counter-electrode current collector layer 150 may be, for example, a thin conductive film. Examples of materials that can be used for the electrode current collector layer 140 and the counter-electrode current collector layer 150 include metals such as stainless steel (SUS (a symbol in Japan Industrial Standards)), aluminum (Al), copper (Cu), and nickel (Ni). The electrode current collector layer 140 and the counter-electrode current collector layer 150 may be formed of different materials.

The thickness of each of the electrode current collector layer 140 and the counter-electrode current collector layer 150 is, for example, greater than or equal to 5 μm and less than or equal to 100 μm but is not limited to this range.

### [Electrode Connection Member]

Next, the electrode connection member 20 will be described.

The electrode connection member 20 is an example of a first connection member and is connected to the side surface 11 of the power-generation element 10. As illustrated in FIG. 1, the electrode connection member 20 includes a metal foil 21, an insulating layer 22, and a plurality of conductive vias 23.

The metal foil 21 is an example of a first metal layer and has a surface 21a facing the side surface 11. The surface 21a is an example of a first surface. The insulating layer 22 is located on the surface 21a.

For the constituent material of the metal foil 21, a material having a high electrical conductivity can be used. Examples of materials that can be used for the metal foil 21 include copper, silver, palladium, nickel, aluminum, iron, stainless steel (SUS), titanium, zinc, and an alloy of some of these. Note that the metal foil denotes a metal member having a substantially uniform thickness, which may also be referred to as a metal plate.

The thickness of the metal foil 21 is, for example, greater than or equal to 5 μm and less than or equal to 100 μm but is not limited to this range. A thicker metal foil 21 reduces the electrical resistance of the metal foil 21. In addition, it is possible to keep the strength of the metal foil 21 larger than or equal to a certain degree, which improves the robustness of the battery 1. In contrast, a thinner metal foil 21 mitigates a decrease in the capacity density of the battery 1. Note that instead of the metal foil 21, a metal member including portions having different thicknesses may be used.

In the example illustrated in FIG. 1, the length of the metal foil 21 in the z-axis direction is longer than the thickness of the power-generation element 10 but is not limited to this configuration. The length of the metal foil 21 in the z-axis direction may be equal to the thickness of the power-generation element 10 or may be shorter than the thickness of the power-generation element 10.

The insulating layer 22 is an example of a first insulating layer and is located on the surface 21a of the metal foil 21. The insulating layer 22 is located so as to cover the counter-electrode layers 120 on the side surface 11. Specifically, the insulating layer 22 is located between the metal foil 21 and the counter-electrode layers 120. More specifically, the insulating layer 22 is in contact with and covers, on the side surface 11, the entire end surfaces of the counter-electrode layers 120 and the counter-electrode current collector layers 150 included in the power-generation element 10. The insulating layer 22 is in contact with and covers, on the side surface 11, portions of the end surfaces of the electrode layers 110, the electrode current collector layers 140, and the solid electrolyte layers 130 included in the power-generation element 10, the portions not being in contact with the conductive vias 23. The insulating layer 22 is formed to be larger than the side surface 11 so as to cover approximately the entire side surface 11.

The insulating layer 22 is electrically insulating. For example, for the constituent substances of the insulating layer 22, substances having an electrical insulating property and an adhesiveness can be used. Specifically, for the insulating layer 22, for example, insulating resins such as an epoxy resin, a phenolic resin, a silicone resin, polyurethane, and an acrylic resin can be used. The insulating layer 22 may contain insulating inorganic filler dispersed in the resin mentioned above. Examples of inorganic filler that can be used include talc, silica, alumina, glass, mica, barium sulfate, and titanium oxide. The size of a piece of inorganic filler is, for example, larger than or equal to 0.01 μm and smaller than or equal to 10 μm but is not limited to this range.

The thickness of the insulating layer 22 is, for example, greater than or equal to 10 μm and less than or equal to 200 μm but is not limited to this range. A thicker insulating layer 22, when a variation or the like occurs in the thickness of the insulating layer 22, reduces the possibility of the metal foil 21 coming into contact with a counter-electrode layer 120, reducing the occurrence of a short circuit. In contrast, a thinner insulating layer 22 mitigates a decrease in the capacity density of the battery 1.

Each of the conductive vias 23 is an example of a first conductive via, passes through the insulating layer 22, and electrically connects the metal foil 21 and electrode layers 110. The plurality of conductive vias 23 electrically connect all of the electrode layers 110 and all of the electrode current collector layers 140 included in the power-generation element 10. In the present embodiment, one or more conductive vias 23 are in contact with each electrode current collector layer 140.

One conductive via 23 is in contact with the end surfaces of one electrode current collector layer 140 and the two electrode layers 110 on both sides of the one electrode current collector layer 140. The conductive via 23 connected to the electrode current collector layer 140 in the uppermost or lowermost layer is in contact with the end surface of one electrode layer 110. The conductive via 23 may be in contact with the end surface of a solid electrolyte layer 130. The conductive vias 23 are not in contact with the counter-electrode layers 120 or the counter-electrode current collector layers 150 included in the power-generation element 10. This configuration prevents the occurrence of a short circuit between the electrode layers 110 and the counter-electrode layers 120.

Each of the conductive vias 23 is in contact with the surface 21a of the metal foil 21. This configuration enables the plurality of conductive vias 23 to be electrically connected to one another via the metal foil 21 so as to be at the same electric potential.

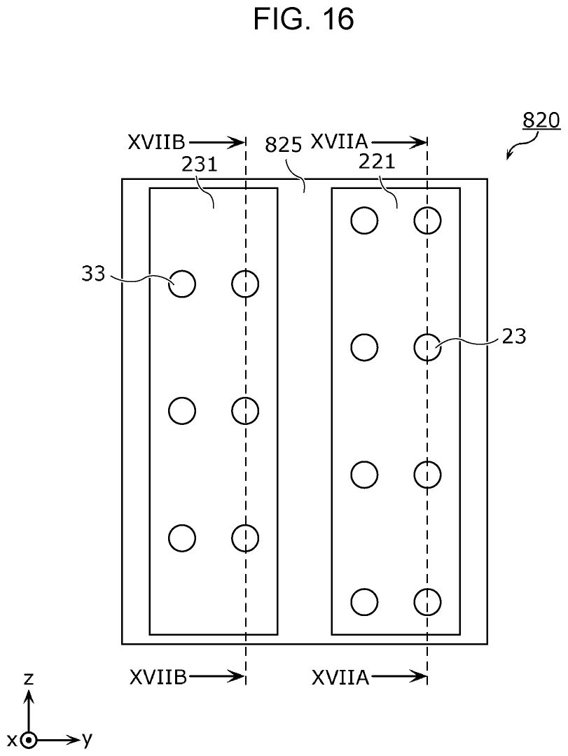

The shape of each conductive via 23 in plan view in the x-axis direction is, for example, circular (see FIG. 16 described later). Two or more circular conductive vias 23 are aligned along the end surface of each electrode layer 110. Since the shape, size, and number of conductive vias 23 in contact with each electrode current collector layer 140 are the same, the resistance of the connection to the electrode layer 110 of each of the battery cells 100 can be uniform. The size of the conductive via 23 is dependent on the thickness of the electrode current collector layer 140 and the electrode layer 110. For example, the length of the conductive via 23 in the z-axis direction is greater than or equal to 10 μm and less than or equal to 300 μm but is not limited to this range.

The shape of the conductive via 23 in plan view is not limited to this one. The shape of the conductive via 23 in plan view may be an elongated shape extending along the end surface of the electrode layer 110. For example, the insulating layer 22 may be separated into two or more parts by conductive vias 23 extending along the end surfaces of the electrode layers 110.

In the present embodiment, the conductive via 23 is a conductive resin composite containing a resin and conductive particles dispersed in the resin. Examples of conductive particles that can be used include silver, copper, nickel, gold, and an alloy of some of these. Examples of resins that can be used include an epoxy resin, a phenolic resin, an acrylic resin, a methacrylic resin, a silicone resin, an aramid resin, a polyimide resin, and a urethane resin.

### [Counter-Electrode Connection Member]

Next, the counter-electrode connection member 30 will be described.

The counter-electrode connection member 30 is an example of a second connection member and is connected to the side surface 12 of the power-generation element 10. As illustrated in FIG. 1, the counter-electrode connection member 30 includes a metal foil 31, an insulating layer 32, and a plurality of conductive vias 33.

The metal foil 31 is an example of a second metal layer and has a surface 31a facing the side surface 12. The surface 31a is an example of a second surface. The insulating layer 32 is located on the surface 31a.

For the constituent material of the metal foil 31, a material having a high electrical conductivity can be used. For example, the material used for the metal foil 21 can also be used for the metal foil 31. The thickness of the metal foil 31 is, for example, greater than or equal to 5 μm and less than or equal to 100 μm. This configuration provides the effects the same as or similar to those of the metal foil 21. Note that the thickness of the metal foil 31 is not limited to this range.

In the example illustrated in FIG. 1, the length of the metal foil 31 in the z-axis direction is longer than the thickness of the power-generation element 10 but is not limited to this configuration. The length of the metal foil 31 in the z-axis direction may be equal to the thickness of the power-generation element 10 or may be shorter than the thickness of the power-generation element 10.

The insulating layer 32 is an example of a second insulating layer and is located on the surface 31a of the metal foil 31. The insulating layer 32 is located so as to cover the electrode layers 110 on the side surface 12. Specifically, the insulating layer 32 is located between the metal foil 31 and the electrode layers 110. More specifically, the insulating layer 32 is in contact with and covers, on the side surface 12, the entire end surfaces of the electrode layers 110 and the electrode current collector layers 140 included in the power-generation element 10. The insulating layer 32 is in contact with and covers, on the side surface 12, portions of the end surfaces of the counter-electrode layers 120, the counter-electrode current collector layers 150, and the solid electrolyte layers 130 included in the power-generation element 10, the portions not being in contact with the conductive vias 33. The insulating layer 32 is formed to be larger than the side surface 12 to cover approximately the entire side surface 12.

The insulating layer 32 is electrically insulating. For example, for the constituent substances of the insulating layer 32, the same material that can be used for the insulating layer 22 can be used. For example, the insulating layer 32 may contain insulating inorganic filler dispersed in a resin.

The thickness of the insulating layer 32 is, for example, greater than or equal to 10 μm and less than or equal to 200 μm. This configuration provides the effects the same as or similar to those of the insulating layer 22. Note that the thickness of the insulating layer 32 is not limited to this range.

Each of the conductive vias 33 is an example of a second conductive via, passes through the insulating layer 32, and electrically connects the metal foil 31 and counter-electrode layers 120. The plurality of conductive vias 33 electrically connect all of the counter-electrode layers 120 and all of the counter-electrode current collector layers 150 included in the power-generation element 10. In the present embodiment, one or more conductive vias 33 are in contact with each counter-electrode current collector layer 150.

One conductive via 33 is in contact with the end surfaces of one counter-electrode current collector layer 150 and the two counter-electrode layers 120 on both sides of the one counter-electrode current collector layer 150. The conductive via 33 may be in contact with the end surface of a solid electrolyte layer 130. The conductive vias 33 are not in contact with the electrode layers 110 or the electrode current collector layers 140 included in the power-generation element 10. This configuration prevents the occurrence of a short circuit between the electrode layers 110 and the counter-electrode layers 120.

Each of the conductive vias 33 is in contact with the surface 31a of the metal foil 31. This configuration enables the plurality of conductive vias 33 to be electrically connected to one another via the metal foil 31 so as to be at the same electric potential.

The shape of each conductive via 33 in plan view in the x-axis direction is, for example, circular (see FIG. 16 described later). Two or more circular conductive vias 33 are aligned along the end surface of each counter-electrode layer 120. Since the shape, size, and number of conductive vias 33 in contact with each counter-electrode current collector layer 150 are the same, the resistance of the connection to the counter-electrode layer 120 of each of the battery cells 100 can be uniform. The size of the conductive via 33 is dependent on the thickness of the counter-electrode current collector layer 150 and the counter-electrode layer 120. For example, the length of the conductive via 33 in the z-axis direction is greater than or equal to 10 μm and less than or equal to 300 μm but is not limited to this range.

Note that the shape of the conductive via 33 in plan view is not limited to this one. The shape of the conductive via 33 in plan view may be an elongated shape extending along the end surface of the counter-electrode layer 120. For example, the insulating layer 32 may be separated into two or more parts by conductive vias 33 extending along the end surfaces of the counter-electrode layers 120.

The conductive via 33 may be composed of the same material that can be used for the conductive via 23. For example, the conductive via 33 is a conductive resin composite containing a resin and conductive particles dispersed in the resin.

In the present embodiment, the plurality of conductive vias 33 and the metal foil 31 electrically connect the counter-electrode layer 120 of each of the battery cells 100, and the plurality of conductive vias 23 and the metal foil 21 electrically connect the electrode layer 110 of each of the battery cells 100. This configuration enables the plurality of battery cells 100 to be connected in parallel. This connection can be achieved in only small portions in close contact with the side surfaces 11 and 12 of the power-generation element 10, increasing the capacity density of the battery 1.

Note that the electrode layer 110 and the electrode current collector layer 140 can be considered to be at the same electric potential. The counter-electrode layer 120 and the counter-electrode current collector layer 150 can be considered to be at the same electric potential. Hence, from the electrical viewpoint, in the state in which a conductive via 23 is in contact with an electrode current collector layer 140 and not in contact with an electrode layer 110, the conductive via 23 can be considered to be electrically connected to the electrode layer 110. Similarly, in the state in which a conductive via 33 is in contact with a counter-electrode current collector layer 150 and not in contact with a counter-electrode layer 120, the conductive via 33 can be considered to be electrically connected to the counter-electrode layer 120. As mentioned above, each of the conductive vias 23 or 33 need not be physically in contact with an electrode layer 110 or a counter-electrode layer 120.

### [Method of Manufacturing Battery]

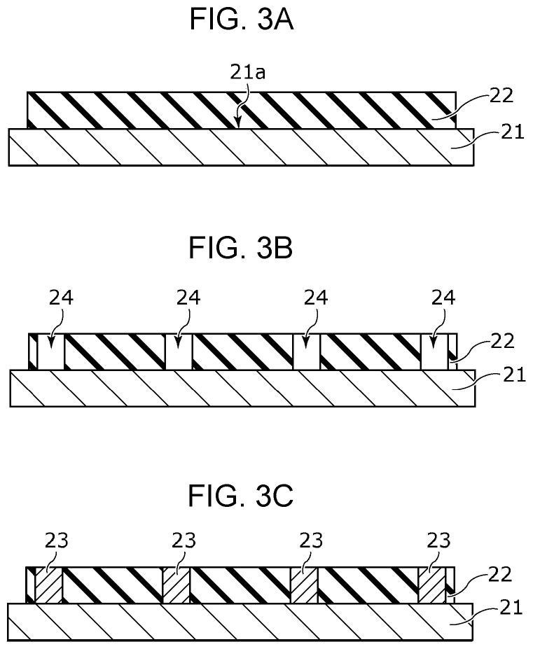

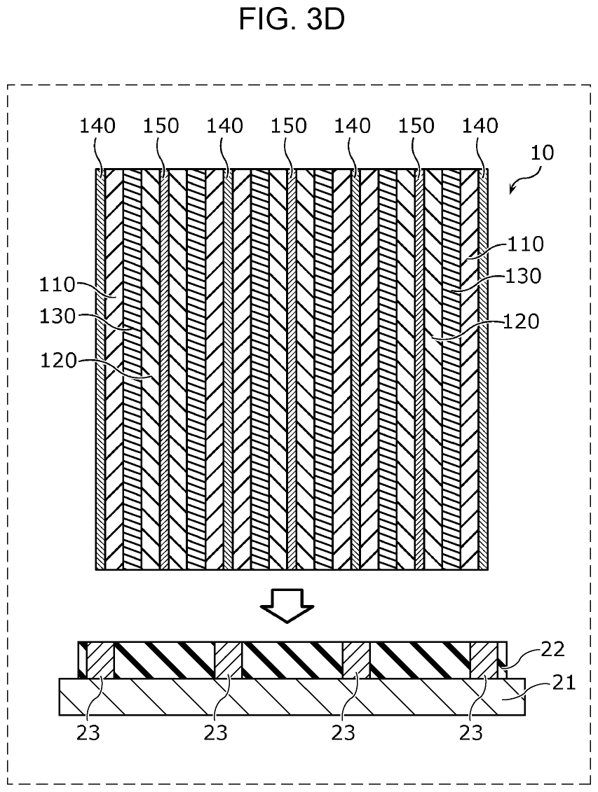

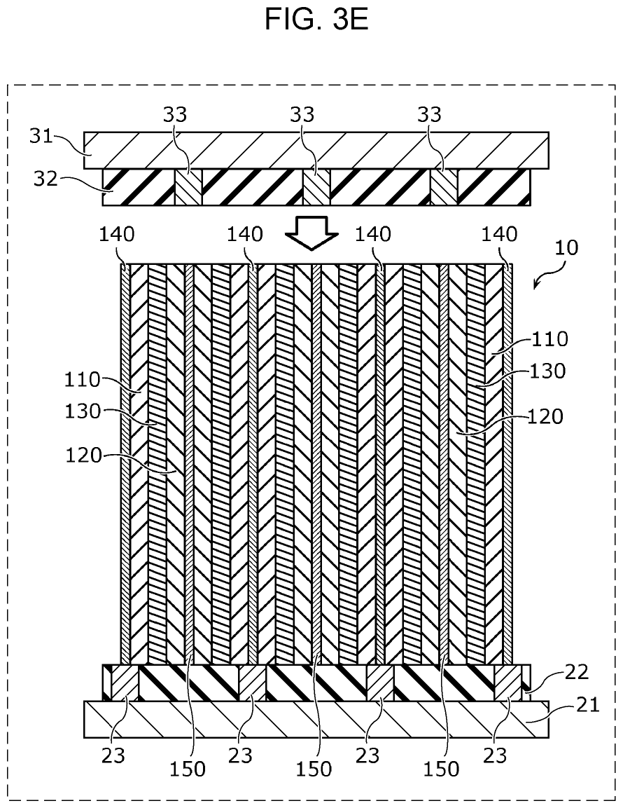

Next, a method of manufacturing the battery 1 according to the present embodiment will be described with reference to FIGS. 3A to 3E. FIGS. 3A to 3E are each a cross-sectional view for explaining a step of the method of manufacturing the battery 1 according to the present embodiment.

The method of manufacturing the battery 1 according to the present embodiment includes, for example, steps of forming the electrode connection member 20 and the counter-electrode connection member 30, a step of preparing the power-generation element 10, and a step of connecting the electrode connection member 20 and the counter-electrode connection member 30 to the power-generation element 10.

### <Step of Forming Connection Members>

First, a step of forming the electrode connection member 20 will be described with reference to FIGS. 3A to 3C.

As illustrated in FIG. 3A, an insulating layer 22 is formed on a main surface of a metal foil 21. The formation of the insulating layer 22 is performed by, for example, printing. Specifically, the insulating layer 22 can be formed by applying a paint in a paste form containing the constituent material of the insulating layer 22 to the main surface of the metal foil 21 by printing. Printing methods that can be used include screen printing, gravure printing, and gravure offset printing but are not limited to these methods.

For example, the insulating layer 22 may be formed by applying an insulating material in a slurry form containing the constituent material of the insulating layer 22 to the metal foil 21. Application methods that can be used include, for example, a die coater, a bar coater, and a reverse roll coater but are not limited to these methods. After the printing or the application, heating may be performed. The heating temperature is, for example, higher than or equal to 60° C. and lower than or equal to 120° C.

Next, as illustrated in FIG. 3B, through holes 24 extending through the insulating layer 22 are formed. The through holes 24 correspond to conductive vias 23 and are formed such that the size, shape, and number of the through holes 24 correspond to those of the conductive vias 23. The through holes 24 are formed by removing parts of the insulating layer 22. Formation methods that can be used for the through holes 24 include, for example, laser processing, pin machining, or drilling but are not limited to these methods.

Next, as illustrated in FIG. 3C, conductive vias 23 are formed so as to be in contact with the metal foil 21. Specifically, the conductive vias 23 are formed by filling the through holes 24 with the constituent material of the conductive vias 23. For example, a paint in the form of paste or ink containing the constituent substances of the conductive vias 23 is applied onto the through holes 24 by printing and is dried to form the conductive vias 23 in the through holes 24. Printing methods that can be used include, for example, screen printing, dispensing, and mask printing but are not limited to these methods.

### <Step of Preparing Power-Generation Element>

Next, a step of preparing power-generation element 10 will be described.

First, for example, a paint in a paste form in which the constituent material of the electrode layer 110 is kneaded together with a solvent is applied to a main surface of an electrode current collector layer 140 and dried to form an electrode layer 110. To increase the density of the electrode layer 110, the electrode layer 110 applied to the electrode current collector layer 140 may be pressed after the drying process.

Next, for example, a paint in a paste form in which the constituent material of the counter-electrode layer 120 is kneaded together with a solvent is applied to a main surface of a counter-electrode current collector layer 150 and dried to form a counter-electrode layer 120. To increase the density of the counter-electrode layer 120, the counter-electrode layer 120 applied to the counter-electrode current collector layer 150 may be pressed after the drying process. Note that either one of the electrode layer 110 and the counter-electrode layer 120 may be formed first, or both may be formed in parallel.

Next, for example, a paint in a paste form in which the constituent material of the solid electrolyte layer 130 is kneaded together with a solvent is applied to a main surface of the electrode layer 110 and/or the counter-electrode layer 120 and dried to form a solid electrolyte layer 130 or part of it. Alternatively, a paint in a paste form may be applied to a releasable film and dried to form a solid electrolyte layer 130.

Next, for example, the electrode current collector layer 140, the electrode layer 110, the solid electrolyte layer 130, the counter-electrode layer 120, and the counter-electrode current collector layer 150 are laminated in this order and pressed and bonded to form a battery cell 100. Examples of pressing methods that can be used include flat plate press, roll press, and isostatic press. From the viewpoint of improving the adhesiveness and density of each layer, heating may be performed while pressing. The heating temperature may be set within a range in which the material of each layer is not chemically changed by heat and is, for example, higher than or equal to 60° C. and lower than or equal to 200° C.

Note that counter-electrode layers 120 may be formed on both of the main surfaces of the counter-electrode current collector layer 150. In this case, an electrode current collector layer 140, an electrode layer 110, a solid electrolyte layer 130, a counter-electrode current collector layer 150 having counter-electrode layers 120 on both sides, a solid electrolyte layer 130, an electrode layer 110, and an electrode current collector layer 140 may be pressed and bonded in this order to form two battery cells 100 with a counter-electrode current collector layer 150 in between.

After a plurality of battery cells 100 are formed, the formed plurality of battery cells 100 are laminated to form a power-generation element 10. Specifically, a plurality of battery cells 100 are laminated such that the laminating order of an electrode layer 110, a solid electrolyte layer 130, and a counter-electrode layer 120 is alternately reversed for each battery cell 100. For example, a plurality of battery cells 100 may be integrated with an adhesive when being laminated. For example, all of the constituents mentioned above may be laminated, and pressed and bonded to integrate a plurality of battery cells 100.

In the present embodiment, a power-generation element 10 having a laminated plurality of battery cells 100 is cut in a direction intersecting the main surface 15 or 16 to form a side surface including a cut surface. Specifically, the power-generation element 10 is cut in a direction orthogonal to the main surface 15 or 16. More specifically, all of the battery cells 100, all of the electrode current collector layers 140, and all of the counter-electrode current collector layers 150 included in the power-generation element 10 are cut all together. For example, the power-generation element 10 is cut in parallel at two places, so that the parallel and flat side surfaces 11 and 12 can be formed. Not only the side surfaces 11 and 12 but also the side surfaces 13 and 14 may be formed by cutting all together.

Methods of cutting all together that can be used include, for example, shearing with a cutting tool, cutting with an end mill, grinding, laser cutting, and jet cutting but are not limited to these methods. From the viewpoint of improving the productivity and effective volume, the cutting method in the cutting step may be performed by a shearing process by cutting with a cutting tool. In the shearing process, the temperature of the power-generation element 10 is unlikely to increase during cutting, and the battery cell 100 is unlikely to deteriorate during cutting. From the viewpoint of improving the flatness of the side surfaces 11 and 12, the shearing process may be cutting with a ultrasonic cutter in which high frequency vibration is transmitted to the cutting edge.

Note that the side surfaces 11 and 12 need not be cut surfaces. For example, the side surfaces 11 and 12 of a power-generation element 10 may be formed by positioning and laminating a plurality of battery cells 100 having the same size. The same applies to the side surfaces 13 and 14.

### <Step of Connecting>

Next, a step of connecting the electrode connection member 20 and the counter-electrode connection member 30 to the power-generation element 10 will be described with reference to FIGS. 3D and 3E.

As illustrated in FIG. 3D, an electrode connection member 20 is connected to the side surface 11 of a prepared power-generation element 10. Specifically, the side surface 11 of the power-generation element 10 is positioned and placed on the electrode connection member 20 such that each conductive via 23 is in contact with the end surfaces of the corresponding electrode layers 110 and electrode current collector layer 140. With this operation, the conductive vias 23 are electrically connected to the electrode layers 110 and the electrode current collector layers 140, and the insulating layer 22 is brought into contact with and covers the end surfaces of the counter-electrode layers 120 and the counter-electrode current collector layers 150.

Note that, for example, in the step of connecting the side surface 11 of the power-generation element 10 to the electrode connection member 20, these may be pressed. The method of pressing is not particularly limited and may be any method that enables the conductive vias 23 to be in contact with the electrode layers 110 so as to electrically connect the electrode layers 110. In addition, to achieve more reliable electrical connection, the electrode connection member 20 may be heated in the connection step. The heating temperature may be set within a range in which the conductive vias 23 and/or the insulating layer 22 can be bonded to the side surface 11 of the power-generation element 10, and each material will not be chemically changed by heat. For example, the heating temperature is higher than or equal to 60° C. and lower than or equal to 200° C.

Next, as illustrated in FIG. 3E, a counter-electrode connection member 30 is connected to the side surface 12 of the power-generation element 10. The concrete connection method is the same as the connection method of the electrode connection member 20.

Note that either one of the electrode connection member 20 and the counter-electrode connection member 30 may be connected first, or both may be connected simultaneously.

Through the steps described above, a battery 1 as illustrated in FIG. 1 is manufactured.

Since the battery 1 according to the present embodiment enables the electrode connection member and the counter-electrode connection member to be in contact with and electrically connected to the side surfaces 11 and 12 of the power-generation element 10 to extend the electrodes and the counter electrodes, it is possible to increase the capacity density of the battery 1. In the method of manufacturing the battery 1 according to the present embodiment, the electrode connection member 20 and the counter-electrode connection member 30 can be formed separately from the step of preparing the power-generation element 10, which simplifies the manufacturing steps of the battery 1. In addition, since the insulating layer and the conductive vias are formed on the metal foil, and then these are joined to the side surface of the power-generation element 10, it is possible to manufacture the battery 1 with a high capacity density easily and precisely.

### Embodiment 2

Next, a method of manufacturing a battery according to Embodiment 2 will be described. In Embodiment 2, the steps of forming the electrode connection member and the counter-electrode connection member and the step of connecting these members differ from those in Embodiment 1. The following description focuses on the differences from Embodiment 1, and description of common points is omitted or simplified.

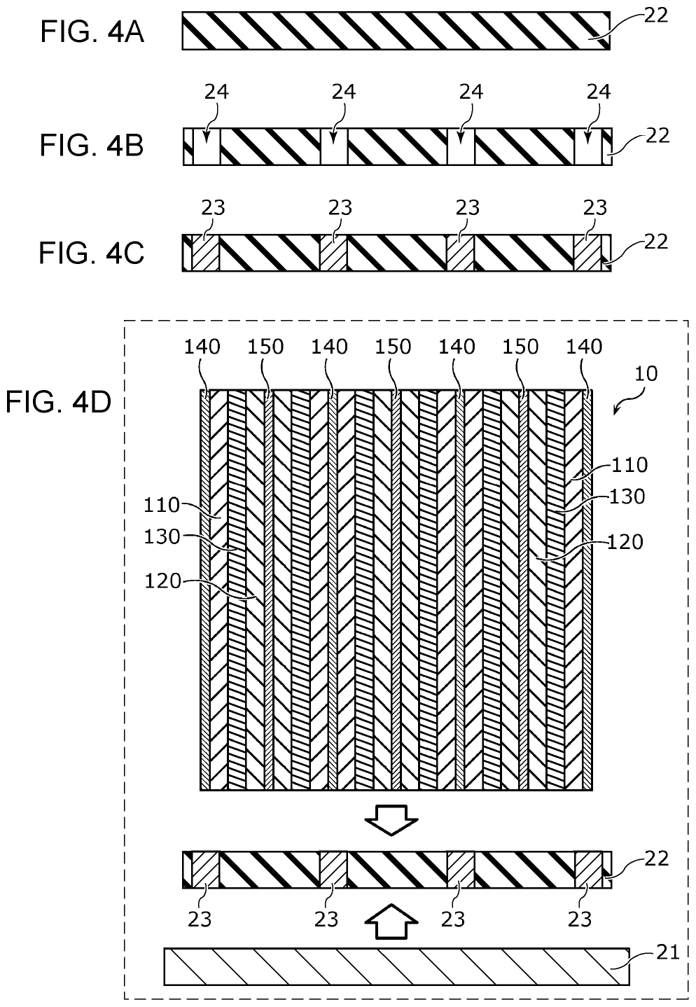

FIGS. 4A to 4D are diagrams illustrating the steps of the method of manufacturing the battery 1 according to the present embodiment.

As in Embodiment 1, the method of manufacturing the battery 1 according to the present embodiment includes, for example, steps of forming the electrode connection member 20 and the counter-electrode connection member 30, a step of preparing the power-generation element 10, and a step of connecting the electrode connection member 20 and the counter-electrode connection member 30 to the power-generation element 10. The step of preparing the power-generation element 10 is the same as that in Embodiment 1.

### <Step of Forming Connection Members>

First, a step of forming the electrode connection member 20 will be described with reference to FIGS. 4A to 4C.

As illustrated in FIG. 4A, an insulating layer 22 is formed. The insulating layer 22 in the present embodiment is, for example, an insulating sheet, which can maintain a certain shape independently of the metal foil 21. In other words, the insulating layer 22 is formed separately from the metal foil 21.

Specifically, the insulating layer 22 can be formed by applying a material in a slurry form containing the constituent material of the insulating layer 22 to a main surface of a releasable base material (not illustrated). Application methods that can be used include, for example, a die coater, a bar coater, a reverse roll coater, and a doctor blade method but are not limited to these. Alternatively, for example, the insulating layer 22 may be formed by impregnating fiber such as glass fiber or aramid fiber with a material in a slurry form containing the constituent material of the insulating layer 22. In addition, after the application or the impregnation, heating may be performed. The heating temperature is, for example, higher than or equal to 60° C. and lower than or equal to 120° C. By peeling the formed insulating layer 22 off the base material, the insulating layer 22 as illustrated in FIG. 4A can be formed independently.

Next, as illustrated in FIG. 4B, through holes 24 extending through the insulating layer 22 are formed. The through holes 24 correspond to conductive vias 23 and are formed such that the size, shape, and number of the through holes 24 correspond to those of the conductive vias 23. The through holes 24 are formed in the same manner as in Embodiment 1.

Next, as illustrated in FIG. 4C, conductive vias 23 are formed in the through holes 24. Specifically, the conductive vias 23 are formed by filling the through holes 24 with the constituent material of the conductive vias 23. For example, a paint in the form of paste or ink containing the constituent substances of the conductive vias 23 is applied onto the through holes 24 by printing and is dried to form the conductive vias 23 in the through holes 24. Printing methods that can be used include, for example, screen printing, dispensing, and mask printing but are not limited to these methods.

### <Step of Connecting>

Next, a step of connecting the electrode connection member 20 and the counter-electrode connection member 30 to the power-generation element 10 will be described with reference to FIG. 4D.

As illustrated in FIG. 4D, an electrode connection member 20 is connected to the side surface 11 of a prepared power-generation element 10. In the present embodiment, an insulating layer 22 with the conductive vias 23 formed, a power-generation element 10, and a metal foil 21 are separately prepared. Specifically, the insulating layer 22 with the conductive vias 23 formed is placed between the side surface 11 of the power-generation element 10 and the metal foil 21 to be in contact with each of these, so that the conductive vias 23 are electrically connected to the electrode layers 110. More specifically, the insulating layer 22 positioned such that each conductive via 23 is in contact with the end surfaces of the corresponding electrode layers 110 and electrode current collector layer 140 is placed between and joined to the side surface 11 of the power-generation element 10 and the metal foil 21. With this operation, the conductive vias 23 are electrically connected to the electrode layers 110 and the electrode current collector layers 140, and the metal foil 21. In addition, the insulating layer 22 is in contact with and covers the end surfaces of the counter-electrode layers 120 and the counter-electrode current collector layers 150.

Next, the counter-electrode connection member 30 is connected in the same manner. In other words, an insulating layer 32 with the conductive vias 33 formed and a metal foil 31 are separately prepared. Specifically, the insulating layer 32 with the conductive vias 33 formed is placed between the side surface 12 of the power-generation element 10 and the metal foil 31 to be in contact with each of these, so that the conductive vias 33 are electrically connected to the counter-electrode layers 120.

During the steps of connecting the electrode connection member 20 and the counter-electrode connection member 30, pressing and/or heating may be performed as in Embodiment 1.

Through the steps described above, a battery 1 as illustrated in FIG. 1 is manufactured.

With the method of manufacturing the battery 1 according to the present embodiment, it is possible to form the through holes 24 in the insulating layer 22 easily and precisely. Hence, it is possible to form the conductive vias 23 in the through holes 24 so as to achieve high charge density, thereby making it possible to increase the reliability of the connection between the conductive vias 23 and the electrode layers 110 and also to reduce the resistance in the connection. The counter-electrode connection member 30 is connected to the side surface 12 in the same or a similar manner, and it provides the same or similar effects.

Note that one of the electrode connection member 20 and the counter-electrode connection member 30 may be connected to the power-generation element 10 in the same manner as in Embodiment 1.

### Embodiment 3

Next, the configuration of a battery according to Embodiment 3 will be described. In Embodiment 3, the configurations of the electrode connection member and the counter-electrode connection member differ from those in Embodiment 1. The following description focuses on the differences from Embodiment 1, and description of common points is omitted or simplified.

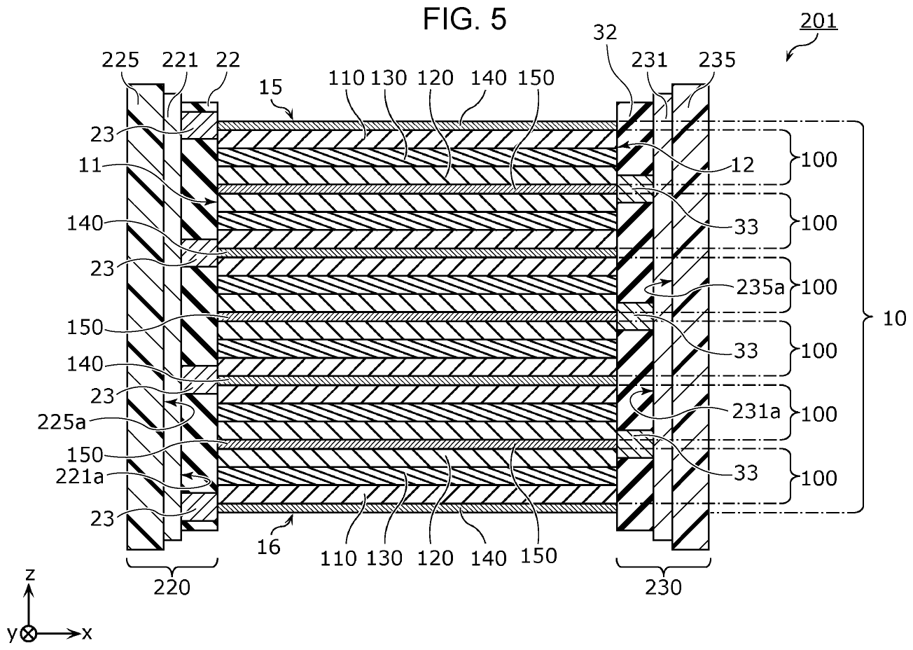

FIG. 5 is a cross-sectional view of a battery 201 according to the present embodiment.

As illustrated in FIG. 5, the battery 201 according to the present embodiment includes a power-generation element 10, an electrode connection member 220, and a counter-electrode connection member 230. The power-generation element 10 is the same as that in Embodiment 1.

### [Electrode Connection Member]

The electrode connection member 220 is an example of a first connection member and is connected to the side surface 11 of the power-generation element 10. As illustrated in FIG. 5, the electrode connection member 220 includes a metal layer 221, an insulating layer 22, conductive vias 23, and a resin film 225. The insulating layer 22 and the conductive vias 23 are the same as those in Embodiment 1.

The resin film 225 is an example of a third insulating layer and has a surface 225a. The resin film 225 serves as a support member for the metal layer 221. The metal layer 221 is located to be in contact with the surface 225a of the resin film 225. The surface 225a is an example of a third surface and faces the side surface 11 of the power-generation element 10.

For the resin film 225, for example, a material having an electrical insulating property, heat resistance, and smoothness can be used. Examples of materials that can be used for the resin film 225 include polyimide, polyethylene terephthalate (PET), polyethylene naphthalate (PEN), polyetheretherketone (PEEK), polyamide, polyester, polyphenylene sulfide (PPS), polyphenylene ether (PPE), and polycarbonate (PC).

The thickness of the resin film 225 is, for example, greater than or equal to 5 μm and less than or equal to 300 μm but is not limited to this range. A thicker resin film 225 enables the strength of the resin film 225 to be kept larger than or equal to a certain degree, increasing the robustness of the battery 201. In contrast, a thinner resin film 225 increases the flexibility and the handling properties of the resin film 225. In addition, it is possible to mitigate a decrease in the capacity density of the battery 201.

The metal layer 221 is an example of a first metal layer and has a surface 221a facing the side surface 11. The surface 221a is an example of a first surface. The insulating layer 22 is located on the surface 221a. The surface of the metal layer 221 opposite to the surface 221a is in contact with the surface 225a of the resin film 225.

For the constituent material of the metal layer 221, a material having a high electrical conductivity can be used. For example, the metal layer 221 contains, copper, silver, gold, platinum, palladium, nickel, aluminum, iron, cobalt, zinc, or an alloy of two or more of these.

The thickness of the metal layer 221 is, for example, greater than or equal to 3 μm and less than or equal to 100 μm but is not limited to this range. A thicker metal layer 221 reduces the electrical resistance of the metal layer 221. In contrast, a thinner metal layer 221 mitigates a decrease in the capacity density of the battery 201.

### [Counter-Electrode Connection Member]

The counter-electrode connection member 230 is an example of a second connection member and is connected to the side surface 12 of the power-generation element 10. As illustrated in FIG. 5, the counter-electrode connection member 230 includes a metal layer 231, an insulating layer 32, conductive vias 33, and a resin film 235. The insulating layer 32 and the conductive vias 33 are the same as those in Embodiment 1.

The resin film 235 is an example of a fourth insulating layer and has a surface 235a. The resin film 235 serves as a support member for the metal layer 231. The metal layer 231 is located to be in contact with the surface 235a of the resin film 235. The surface 235a is an example of a fourth surface and faces the side surface 12 of the power-generation element 10.

The resin film 235 can be composed of the same material that can be used for the resin film 225. The thickness of the resin film 235 is, for example, greater than or equal to 5 μm and less than or equal to 300 μm. The resin film 235 with this configuration provides the effects the same as or similar to those of the resin film 225. The thickness of the resin film 235 is not limited to this range.

The metal layer 231 is an example of a second metal layer and has a surface 231a facing the side surface 12. The surface 231a is an example of a second surface. The insulating layer 32 is located on the surface 231a. The surface of the metal layer 231 opposite to the surface 231a is in contact with the surface 235a of the resin film 235.

For the constituent material of the metal layer 231, a material having a high electrical conductivity can be used. For the constituent material of the metal layer 231, for example, the same material that can be used for the metal layer 221 can be used. The thickness of the metal layer 231 is, for example, greater than or equal to 3 μm and less than or equal to 100 μm. The metal layer 231 with this configuration provides the effects the same as or similar to those of the metal layer 221. The thickness of the metal layer 231 is not limited to this range.

[Method of Manufacturing Battery]

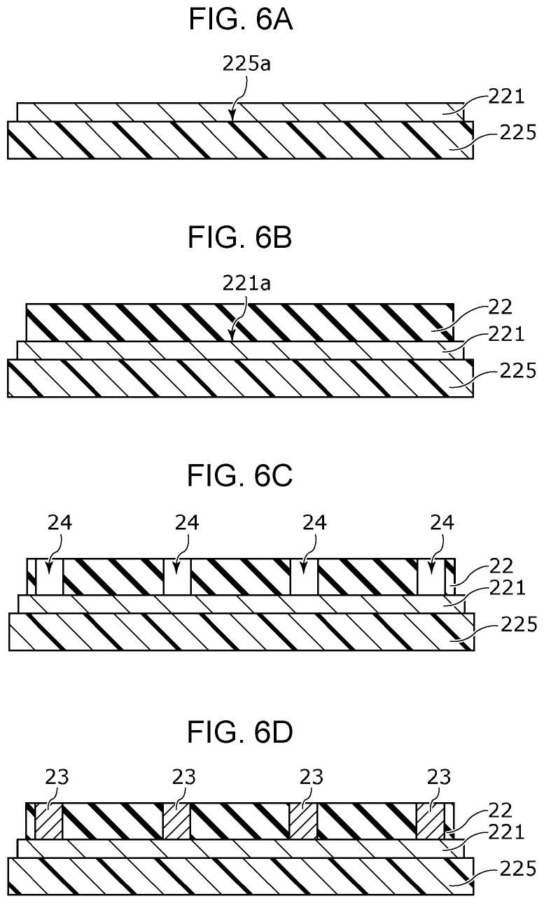

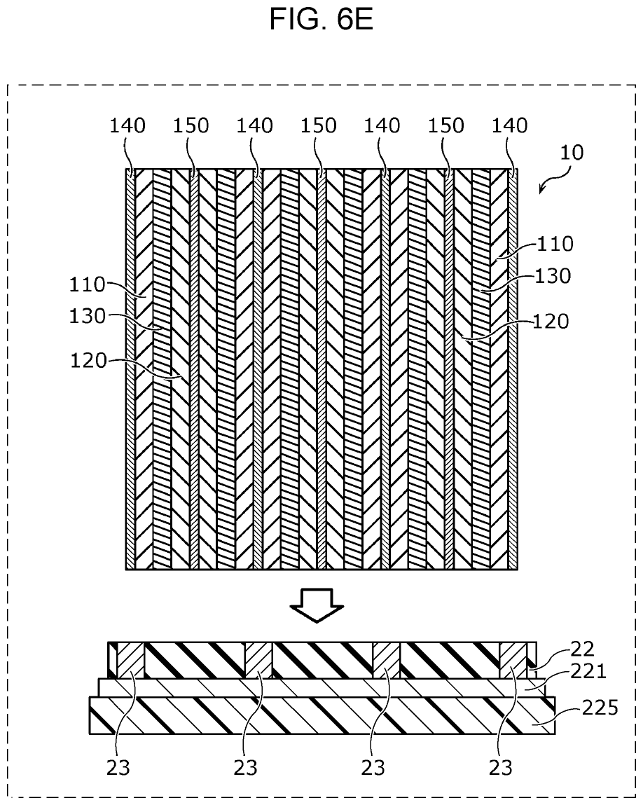

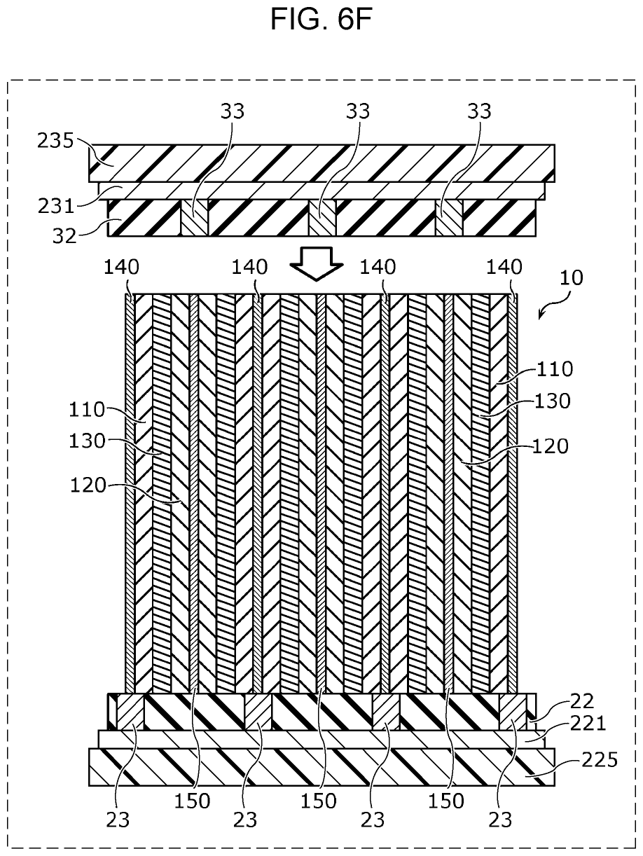

Next, a method of manufacturing the battery 201 according to the present embodiment will be described with reference to FIGS. 6A to 6F. FIGS. 6A to 6F are each a cross-sectional view for explaining a step of the method of manufacturing the battery 201 according to the present embodiment.

The method of manufacturing the battery 201 according to the present embodiment includes, for example, steps of forming the electrode connection member 220 and the counter-electrode connection member 230, a step of preparing the power-generation element 10, and a step of connecting the electrode connection member 220 and the counter-electrode connection member 230 to the power-generation element 10. The step of preparing the power-generation element 10 is the same as that in Embodiment 1.

### <Step of Forming Connection Members>

First, a step of forming the electrode connection member 220 will be described with reference to FIGS. 6A to 6D.

As illustrated in FIG. 6A, a metal layer 221 is formed on the surface 225a of a resin film 225. The method of forming the metal layer 221 may be selected as appropriate and is not particularly limited. Examples of methods that can be used include a method of bonding the metal foil, vacuum vapor deposition, sputtering, and plating.

Next, as illustrated in FIG. 6B, an insulating layer 22 is formed on the surface 221a of the metal layer 221. For example, the insulating layer 22 is formed by at least one of application or printing as in Embodiment 1.

Next, as illustrated in FIG. 6C, through holes 24 extending through the insulating layer 22 are formed. The through holes 24 correspond to conductive vias 23 and are formed such that the size, shape, and number of the through holes 24 correspond to those of the conductive vias 23. The through holes 24 are formed by removing parts of the insulating layer 22 as in Embodiment 1.

Next, as illustrated in FIG. 6D, conductive vias 23 are formed so as to be in contact with the metal layer 221. Specifically, the conductive vias 23 are formed by filling the through holes 24 with the constituent material of the conductive vias 23. For example, as in Embodiment 1, a paint in the form of paste or ink containing the constituent substances of the conductive vias 23 is applied onto the through holes 24 by printing and is dried to form the conductive vias 23 in the through holes 24.

The step of forming the counter-electrode connection member 230 is the same as or similar to the step of forming the electrode connection member 220, and hence, description thereof is omitted. In the step of forming the counter-electrode connection member 230, the positions at which the conductive vias 33 are formed differ from the positions where the conductive via 23 are placed.

### <Step of Connecting>

Next, a step of connecting the electrode connection member 220 and the counter-electrode connection member 230 to the power-generation element 10 will be described with reference to FIGS. 6E and 6F.

As illustrated in FIG. 6E, an electrode connection member 220 is connected to the side surface 11 of a prepared power-generation element 10. Specifically, the side surface 11 of the power-generation element 10 is positioned and placed on the electrode connection member 220 such that each conductive via 23 is in contact with the end surfaces of the corresponding electrode layers 110 and electrode current collector layer 140. With this operation, the conductive vias 23 are electrically connected to the electrode layers 110 and the electrode current collector layers 140, and the insulating layer 22 is in contact with and covers the end surfaces of the counter-electrode layers 120 and the counter-electrode current collector layers 150.

Next, as illustrated in FIG. 6F, a counter-electrode connection member 230 is connected to the side surface 12 of the power-generation element 10. The concrete connection method is the same as the connection method of the electrode connection member 220. During the steps of connecting the electrode connection member 220 and the counter-electrode connection member 230, pressing and/or heating may be performed as in Embodiment 1.

Through the steps described above, a battery 201 as illustrated in FIG. 5 is manufactured.

Since the battery 201 according to the present embodiment enables the electrode connection member and the counter-electrode connection member to be in contact with and electrically connected to the side surfaces 11 and 12 of the power-generation element 10 to extend the electrodes and the counter electrodes, it is possible to increase the capacity density of the battery 201. In the method of manufacturing the battery 201 according to the present embodiment, the electrode connection member 220 and the counter-electrode connection member 230 can be formed separately from the step of preparing the power-generation element 10, which simplifies the manufacturing steps of the battery 201. In addition, since the insulating layer and the conductive vias are formed on a resin film and are then joined to the side surface of the power-generation element 10, it is possible to manufacture the battery 201 with a high capacity density easily and precisely.

Use of the resin films 225 and 235 further increases the robustness of the battery 201. This configuration also prevents the metal layer 221 or 231 from coming into contact with an outside object and causing the occurrence of a short circuit. Thus, it is possible to provide the battery 201 with high reliability. In addition, the shapes of the metal layers 221 and 231 can be modified on the resin films 225 and 235, which increases the degree of freedom in wiring while maintaining the robustness of the battery 201.

### Embodiment 4

Next, a method of manufacturing a battery according to Embodiment 4 will be described. Embodiment 4 differs from Embodiment 1 in that pads are formed on the side surfaces of the power-generation element. The following description focuses on the differences from Embodiment 1, and description of common points is omitted or simplified.

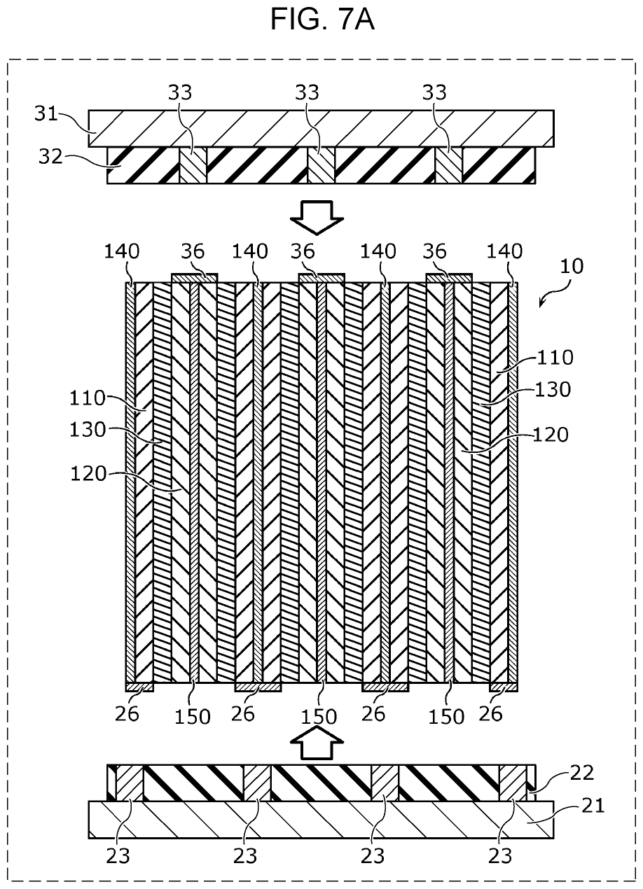

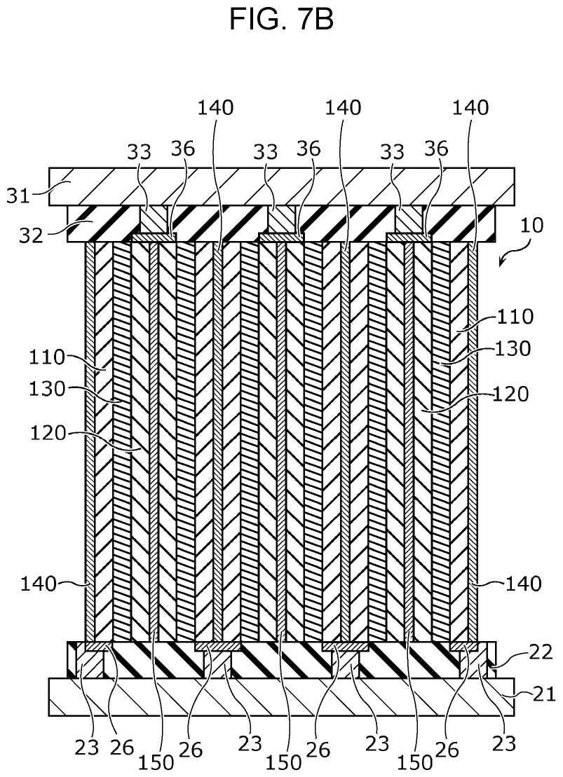

FIGS. 7A and 7B are each a cross-sectional view for explaining a step of the method of manufacturing the battery according to the present embodiment. Note that FIGS. 7A and 7B each illustrate a step of the method of manufacturing the battery including metal foils 21 and 31 as in the battery 1 according to Embodiment 1.

The method of manufacturing the battery according to the present embodiment, as in Embodiment 1, includes, for example, steps of forming the electrode connection member 20 and the counter-electrode connection member 30, a step of preparing the power-generation element 10, and a step of connecting the electrode connection member 20 and the counter-electrode connection member 30 to the power-generation element 10. The steps of forming the electrode connection member 20 and the counter-electrode connection member 30 are the same as those in Embodiment 1.

In the step of preparing the power-generation element 10, a plurality of battery cells 100 are laminated, the laminated battery cells 100 are cut all together as necessary to form flat side surfaces 11 and 12, and then, pads 26 and 36 are formed on the side surfaces 11 and 12. Specifically, the pads 26 are formed so as to be electrically connected to the electrode layers 110 on the side surface 11 at the positions corresponding to the conductive vias 23 to be connected to. Each pad 26 is, for example, in contact with the end surfaces of electrode layers 110 and an electrode current collector layer 140 on the side surface 11. Similarly, the pads 36 are formed so as to be electrically connected to the counter-electrode layers 120 on the side surface 12 at the positions corresponding to the conductive vias 33 to be connected to. Each pad 36 is, for example, in contact with the end surfaces of counter-electrode layers 120 and a counter-electrode current collector layer 150 on the side surface 12.

The shape of the pad 26 in plan view is, for example, circular. For example, the circular pads 26 are in one-to-one correspondence with the conductive vias 23, and the pad 26 is one size larger than the conductive via 23. For example, the length of the pad 26 in the z-axis direction is greater than or equal to 30 μm and less than or equal to 400 μm but is not limited to this range. The shape and size of the pad 26 may be the same as those of the conductive via 23.

The shape of the pad 26 in plan view is not limited to this one. The shape of the pad 26 in plan view may be an elongated shape extending along the end surface of the electrode layer 110. For example, the insulating layer 22 may be separated into two or more parts by conductive vias 23 each extending along the end surface of an electrode layer 110.

The shape, size, and arrangement of the pad 36 are the same as or similar to those of the pads 26. For example, the pads 36 are in one-to-one correspondence with the conductive vias 33, and the pad 36 is one size larger than the conductive via 33. Modifications applicable to the pad 26 are also applicable to the pad 36.

Each of the pads 26 and 36 contains, for example, a resin and conductive particles dispersed in the resin. Examples of conductive particles that can be used include silver, copper, nickel, gold, and an alloy of some of these. Examples of resins that can be used include an epoxy resin, a phenolic resin, an acrylic resin, a methacrylic resin, a silicone resin, an aramid resin, a polyimide resin, and a urethane resin.

For example, the pads 26 can be formed by applying a paint in the form of paste or ink containing the constituent substances of the pad 26 to the side surface 11 of the power-generation element 10 such that each pad 26 is in contact with the corresponding electrode layers 110, and drying the paint. Similarly, the pads 36 can be formed by applying a paint in the form of paste or ink containing the constituent substances of the pad 36 to the side surface 12 of the power-generation element 10 such that each pad 26 is in contact with the corresponding counter-electrode layers 120, and drying the paint. Application methods that can be used include, for example, screen printing, dispensing, and mask printing but are not limited to these methods.

After that, the metal foil 21 with the insulating layer 22 and the conductive vias 23 formed is connected to the side surface 11 of the power-generation element 10. The hardness of the insulating layer 22, the conductive vias 23, and the pads 26 is adjusted so that the pads 26 are embedded in the insulating layer 22 and/or the conductive vias 23. This configuration makes it possible to achieve a favorable contact between the pads 26 and the conductive vias 23 thereby achieving a lower resistance, and also increases the adhesiveness between the insulating layer 22 and the side surface 11.

In addition, the metal foil 31 with the insulating layer 32 and the conductive vias 33 formed is connected to the side surface 12 of the power-generation element 10. As with the pads 26, the pads 36 are embedded in the insulating layer 32 and/or the conductive vias 33. This configuration makes it possible to achieve a favorable contact between the pads 36 and the conductive vias 33 thereby achieving a lower resistance, and also increases the adhesiveness between the insulating layer 32 and the side surface 12. Note that in each connecting process, pressing and/or heating may be performed as in Embodiment 1.

Through these steps, the battery having the pads 26 and 36 is manufactured as illustrated in FIG. 7B.

Since the configuration in the present embodiment includes the pads 26, it is possible to increase the reliability of the connection between the conductive vias 23 and the electrode layers 110. Similarly, the pads 36 increase the reliability of the connection between the conductive vias 33 and the counter-electrode layers 120.

Although in the present embodiment, an example of manufacturing the battery including the metal foils 21 and 31 has been described as in Embodiment 1, this method is also applicable to the method of manufacturing a battery including the metal layers 221 and 231 and the resin films 225 and 235 as in Embodiment 3.

### Embodiment 5

Next, Embodiment 5 will be described. In Embodiment 5, the metal foils of the electrode connection member and the counter-electrode connection member differ from those in Embodiment 1. The following description focuses on the differences from Embodiment 1, and description of common points is omitted or simplified.

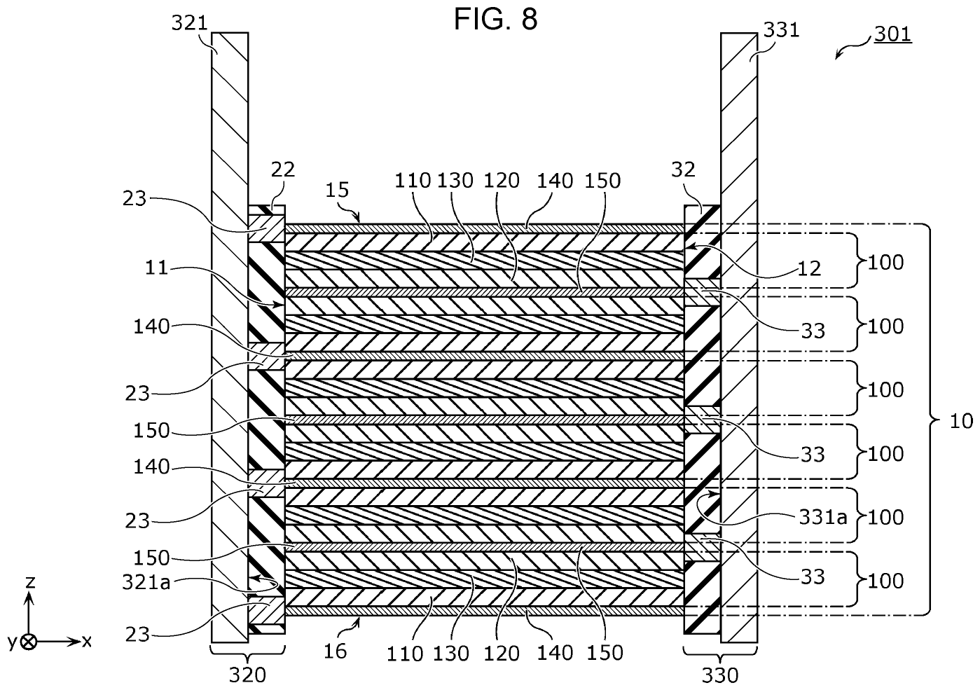

FIG. 8 is a cross-sectional view of a battery 301 according to the present embodiment.

As illustrated in FIG. 8, the battery 301 according to the present embodiment includes a power-generation element 10, an electrode connection member 320, and a counter-electrode connection member 330. The power-generation element 10 is the same as that in Embodiment 1.

### [Electrode Connection Member]

The electrode connection member 320 is an example of a first connection member. The electrode connection member 320 differs from the electrode connection member 20 according to Embodiment 1 in that the electrode connection member 320 includes a metal foil 321 instead of the metal foil 21.

The metal foil 321 is an example of a first metal layer and extends in a direction away from the side surface 11 of the power-generation element 10. The phrase “a direction away from the side surface 11” mentioned here refers to a direction parallel to the side surface 11 (in the z-axis direction) but is not limited to this direction. For example, the metal foil 321 may be curved or bent and then extend in a direction orthogonal to the side surface 11 (for example, the negative direction of the x-axis). Alternatively, the metal foil 321 may be curved or bent and then extend in a direction obliquely intersecting the side surface 11.

The extended length of the metal foil 321 is not particularly limited and may be, for example, longer than or equal to the thickness of the power-generation element 10 (the length in the z-axis direction). Although the metal foil 321 extends mainly in the positive direction of the z-axis in FIG. 8, the metal foil 321 may extend also in the negative direction of the z-axis. The extension length of the metal foil 321 on the positive side of the z-axis may be equal to the extension length of the metal foil 321 on the negative side of the z-axis.

An insulating layer 22 is provided on a surface 321a of the metal foil 321. Although in the present embodiment, the insulating layer 22 is provided in the region of the surface 321a facing the side surface 11 of the power-generation element 10, and the insulating layer 22 is not provided in the region of the surface 321a not facing the side surface 11, the present disclosure is not limited to this configuration. The insulating layer 22 may extend in the manner the same as or similar to that of the metal foil 321. For example, the insulating layer 22 may be provided so as to cover the entire surface 321a, in other words, may be provided also in the extension portion of the surface 321a. Note that the region facing the side surface 11 refers to the region overlapping the side surface 11 in plan view of the side surface 11.

### [Counter-Electrode Connection Member]

The counter-electrode connection member 330 is an example of a second connection member. The counter-electrode connection member 330 differs from the counter-electrode connection member 30 according to Embodiment 1 in that the counter-electrode connection member 330 includes a metal foil 331 instead of the metal foil 31.

The metal foil 331 is an example of a second metal layer and extends in a direction away from the side surface 12 of the power-generation element 10. The extending direction and extended length of the metal foil 331 may be modified in the manner the same as or similar to that of the metal foil 321. Although the metal foil 331 in the example illustrated in FIG. 8 extends mainly in the positive direction of the z-axis in the same manner as the metal foil 321, the present disclosure is not limited to this configuration. The main extending direction of the metal foil 331 may differ from the extending direction of the metal foil 321. For example, in a configuration in which the main extending direction of the metal foil 331 is opposite to the extending direction of the metal foil 321, the metal foil 321 and the metal foil 331 can be away from each other, and this will prevent the occurrence of a short circuit. Note that the phrase “the main extending direction” refers to the direction in which the metal foil extends by the longest length. An insulating layer 32 is provided on a surface 331a of the metal foil 331.

Although in the present embodiment, the insulating layer 32 is provided in the region of the surface 331a facing the side surface 12 of the power-generation element 10, and the insulating layer 32 is not provided in the region of the surface 331a not facing the side surface 12, the present disclosure is not limited to this configuration. The insulating layer 32 may extend in the manner the same as or similar to that of the metal foil 331. For example, the insulating layer 32 may be provided so as to cover the entire surface 331a, in other words, may be provided also in the extension portion of the surface 331a.

In the present embodiment, both the metal foils 321 and 331 extend. The extension portion of each of the metal foils 321 and 331 can be used for electrical connection to another device.

The method of manufacturing the battery 301 according to the present embodiment is the same as or similar to the method of manufacturing the battery 1 according to Embodiment 1. Metal foils 321 and 331 longer than the thickness of the power-generation element 10 are prepared instead of the metal foils 21 and 31, and the insulating layers 22 and 32 are formed in ranges approximately the same as the thickness of the power-generation element 10.

In the battery 301 according to the present embodiment, the extension portion of each of the metal foils 321 and 331 can be used for electrical connection to another device.

### Embodiment 6

Next, the configuration of a battery according to Embodiment 6 will be described. In Embodiment 6, the base materials of the electrode connection member and the counter-electrode connection member differ from those in Embodiment 3. The following description focuses on the differences from Embodiments 3 and 5, and description of common points is omitted or simplified.

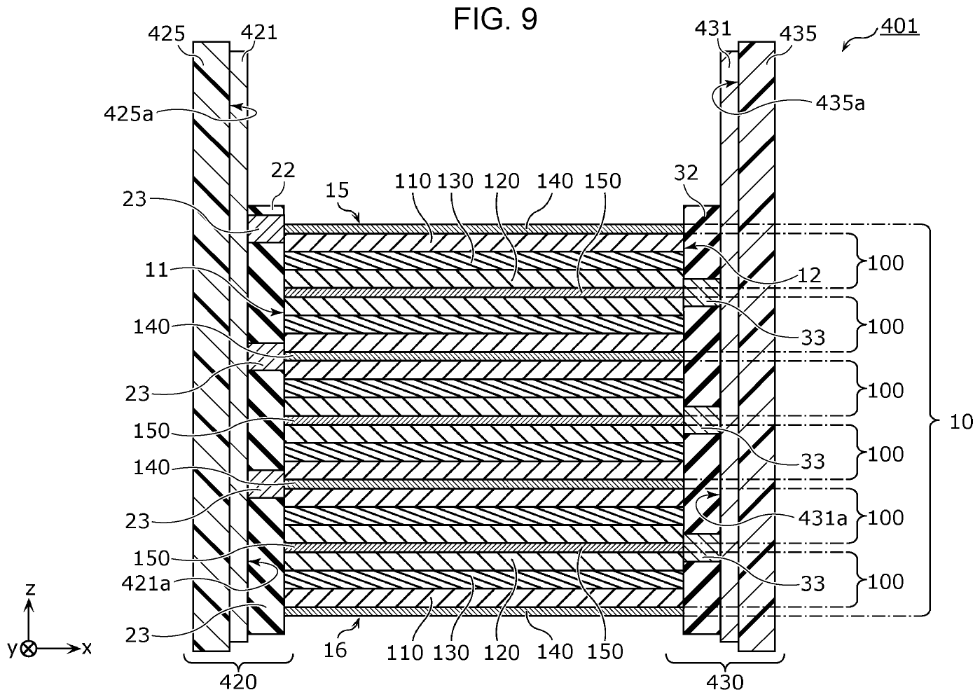

FIG. 9 is a cross-sectional view of a battery 401 according to the present embodiment.

As illustrated in FIG. 9, the battery 401 according to the present embodiment includes a power-generation element 10, an electrode connection member 420, and a counter-electrode connection member 430. The power-generation element 10 is the same as that in Embodiment 1.

### [Electrode Connection Member and Counter-Electrode Connection Member]

The electrode connection member 420 is an example of a first connection member. The electrode connection member 420 differs from the electrode connection member 220 according to Embodiment 3 in that the electrode connection member 420 includes a metal layer 421 and a resin film 425 instead of the metal layer 221 and the resin film 225.

The metal layer 421 is an example of a first metal layer. The resin film 425 is an example of a third insulating layer. The metal layer 421 is provided on a surface 425a of the resin film 425. Both the metal layer 421 and the resin film 425 extend in a direction away from the side surface 11 of the power-generation element 10.

The insulating layer 22 is provided in the region of a surface 421a of the metal layer 421 facing the side surface 11. The extending direction and the extended length of each of the metal layer 421 and the resin film 425 are the same as those of the metal foil 321 according to Embodiment 5, and the modifications applicable to the metal foil 321 are also applicable to the metal layer 421 and the resin film 425.

The counter-electrode connection member 430 is an example of a second connection member. The counter-electrode connection member 430 differs from the counter-electrode connection member 230 according to Embodiment 3 in that the counter-electrode connection member 430 includes a metal layer 431 and a resin film 435 instead of the metal layer 231 and the resin film 235.

The metal layer 431 is an example of a second metal layer. The resin film 435 is an example of a fourth insulating layer. The metal layer 431 is provided on a surface 435a of the resin film 435. Both the metal layer 431 and the resin film 435 extend in a direction away from the side surface 12 of the power-generation element 10.

The insulating layer 32 is provided in the region of a surface 431a of the metal layer 431 facing the side surface 12. The extending direction and the extended length of the metal layer 431 and the resin film 435 are the same as those of the metal foil 331 according to Embodiment 5, and the modifications applicable to the metal foil 331 are also applicable to the metal layer 431 and the resin film 435.

The method of manufacturing the battery 401 according to the present embodiment is the same as or similar to the method of manufacturing the battery 201 according to Embodiment 3. Instead of the resin films 225 and 235, resin films longer than the thickness of the power-generation element 10 are prepared for the resin films 425 and 435, and the metal layers 421 and 431 are formed on the surfaces 425a and 435a, respectively, in a range longer than the thickness of the power-generation element 10.

In the battery 401 according to the present embodiment, the extension portion of each of the metal layers 421 and 431 can be used for electrical connection to another device.

### Embodiment 7

Next, the configuration of a battery according to Embodiment 7 will be described. Embodiment 7 differs from Embodiment 1 in that a metal layer is in contact with the main surfaces of the power-generation element. The following description focuses on the differences from Embodiments 1 and 6, and description of common points is omitted or simplified.

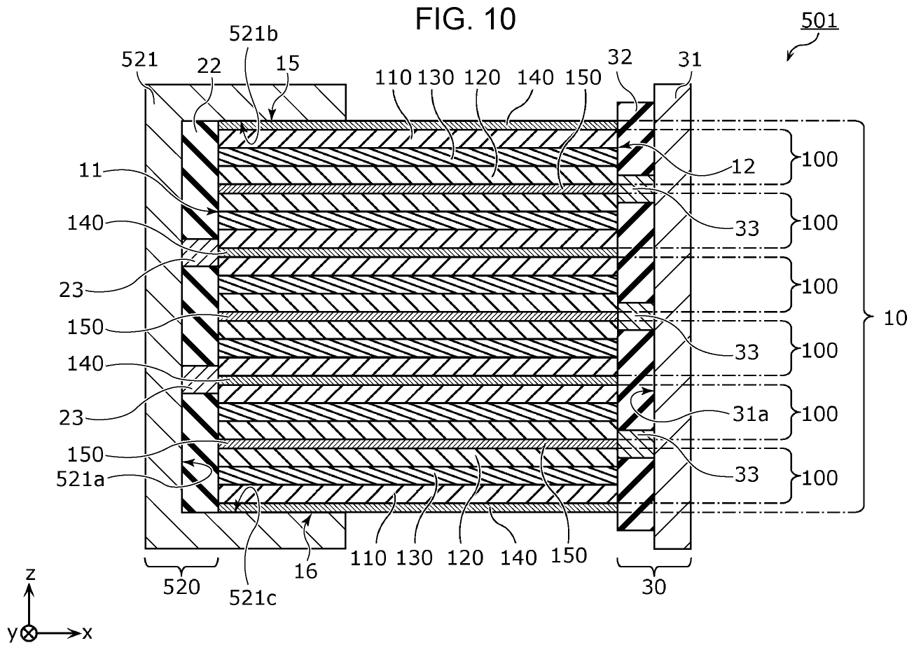

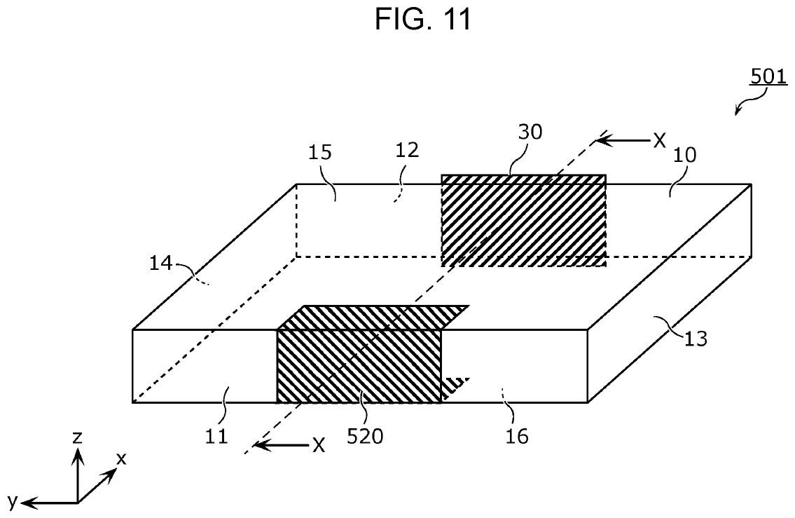

FIG. 10 is a cross-sectional view of a battery 501 according to the present embodiment. FIG. 10 is a cross-sectional view taken along line X-X in FIG. 11. FIG. 11 is a perspective view of the battery 501 according to the present embodiment.

As illustrated in FIGS. 10 and 11, the battery 501 according to the present embodiment includes a power-generation element 10, an electrode connection member 520, and a counter-electrode connection member 30. The power-generation element 10 and the counter-electrode connection member 30 are the same as those in Embodiment 1.

The electrode connection member 520 differs from the electrode connection member 320 according to Embodiment 5 in that the electrode connection member 520 includes a metal foil 521 instead of the metal foil 321.

the metal foil 521 has a configuration in which the portions of the metal foil 321 according to Embodiment 5 extending in directions away from the side surface 11 are folded. Specifically, the metal foil 521 has not only a surface 521a facing the side surface 11 of the power-generation element 10 but also surfaces 521b and 521c facing the main surfaces 15 and 16, respectively, of the power-generation element 10.

As illustrated in FIG. 10, the metal foil 521 is connected to both the main surfaces 15 and 16 of the power-generation element 10. Specifically, the metal foil 521 is connected to the main surface 15 which is the upper surface of the electrode current collector layer 140 located in the uppermost layer of the power-generation element 10, and is also connected to the main surface 16 which is the lower surface of the electrode current collector layer 140 located in the lowermost layer of the power-generation element 10. The method of manufacturing the battery 501 according to the present embodiment is the same as or similar to the method of manufacturing the battery 301 according to Embodiment 5. For example, a metal foil 521 longer than the thickness of the power-generation element 10 is connected to the side surface 11 of a power-generation element 10, and then, the extension portions of the metal foil 521 are bent so as to make contact with the main surfaces 15 and 16 by pressing or the like. With this process, the surface 521b of the metal foil 521 makes contact with the main surface 15, and the surface 521c of the metal foil 521 makes contact with the main surface 16.

In the battery 501 according to the present embodiment, the contact area between the metal foil 521 and the electrode current collector layer 140 is larger, which decreases the resistance of the connection.

In the present embodiment, since both the main surfaces 15 and 16 of the power-generation element 10 are main surfaces of electrode current collector layers 140, the metal foil 521 of the electrode connection member 520 is brought into contact with both the main surfaces 15 and 16. In the case in which at least one of the main surface 15 or 16 of the power-generation element 10 is a main surface of a counter-electrode current collector layer 150, the metal foil 31 of the counter-electrode connection member 30 may be brought into contact with each of the main surfaces 15 and 16.

Although the battery 501 is an example including metal foils as with the battery 301 according to Embodiment 5, the present disclosure is not limited to this configuration. The battery 501 may include resin films and metal layers as with the battery 401 according to Embodiment 6. In this case, a metal layer provided on a main surface of a resin film is brought into contact with the main surfaces 15 and 16 of the power-generation element 10.

### Embodiment 8

Next, the configuration of a battery according to Embodiment 8 will be described. Embodiment 8 differs from Embodiment 5 in that Embodiment 8 includes an outer case enclosing the power-generation element. The following description focuses on the differences from Embodiment 5, and description of common points is omitted or simplified.

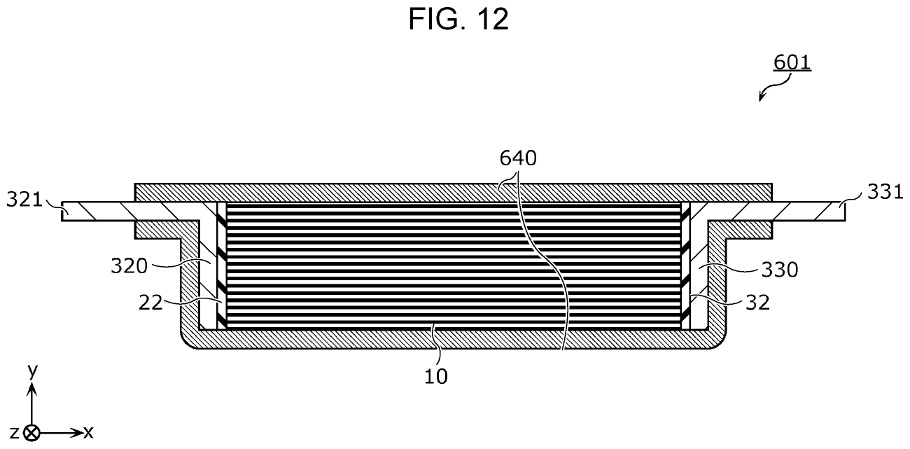

FIG. 12 is a cross-sectional view of a battery 601 according to the present embodiment.

As illustrated in FIG. 12, the battery 601 according to the present embodiment includes a power-generation element 10, an electrode connection member 320, a counter-electrode connection member 330, and an outer case 640. The power-generation element 10 is the same as that in Embodiment 5. The metal foil 321 of the electrode connection member 320 and the metal foil 331 of the counter-electrode connection member 330 are the same as those in Embodiment 5 except that the metal foils 321 and 331 in the present embodiment are bent and then extend. In FIG. 12, illustration of the concrete layer structure of the power-generation element 10 is omitted. In addition, illustration of the conductive vias 23 and 33 is also omitted.

The outer case 640 contains the power-generation element 10. The outer case 640 is composed of, for example, two facing lamination films the outer peripheral portions of which are welded by thermocompression bonding. Alternatively, the outer case 640 may be one lamination film in the form of a bag.

As illustrated in FIG. 12, each of the metal foils 321 and 331 extends to the outside of the outer case 640. The portion of the metal foil 321 located outside the outer case 640 and the portion of the metal foil 331 located outside the outer case 640 are used for electrical connection to another device or the like. In other words, the metal foils 321 and 331 function as output terminals of the battery 601.

In addition, lead terminals for outputting electrical current may be attached to the portions of the metal foils 321 and 331, exposed to the outside of the outer case 640.

In the battery 601 according to the present embodiment, the electrode connection member 320 and the counter-electrode connection member 330 located on the side surfaces 11 and 12, respectively, of the power-generation element 10 can serve as output electrodes. This improves the capacity density of the battery 601. In addition, enclosing the power-generation element 10 with the outer case 640 mitigates a deterioration of the power-generation element 10. This makes it possible to provide the battery 601 with high reliability.

Although the battery 601 in the present embodiment is an example of enclosing the power-generation element 10 of the battery 301 according to Embodiment 5 with the outer case 640, the present disclosure is not limited to this configuration. The battery 601 may be one enclosing the power-generation element 10 of the battery 401 according to Embodiment 6 with the outer case 640.

Although the description in the present embodiment is based on an example in which the outer case 640 is composed of lamination films, the present disclosure is not limited to this configuration. The outer case 640 may be a metal can or the like.

### Embodiment 9

Next, the configuration of a battery according to Embodiment 9 will be described. In Embodiment 9, the positions of the electrode connection member and the counter-electrode connection member differ from those in Embodiment 1. The following description focuses on the differences from Embodiment 1, and description of common points is omitted or simplified.

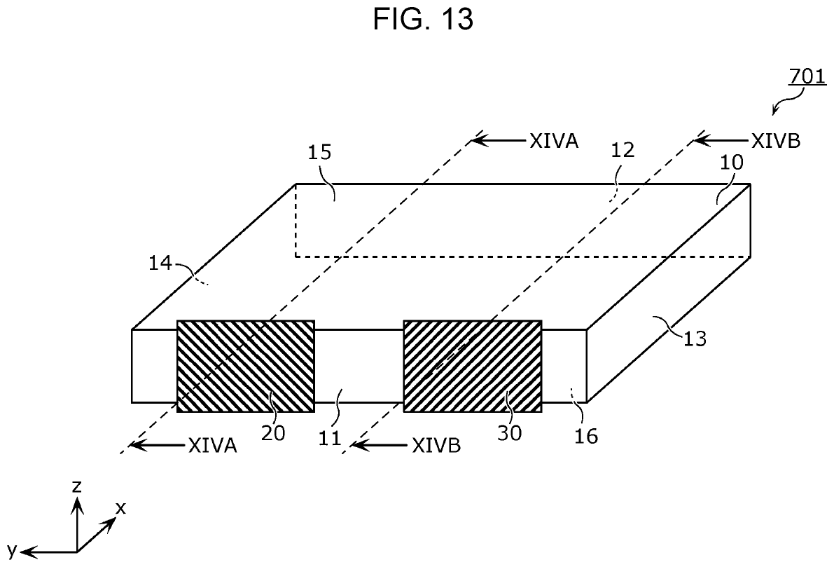

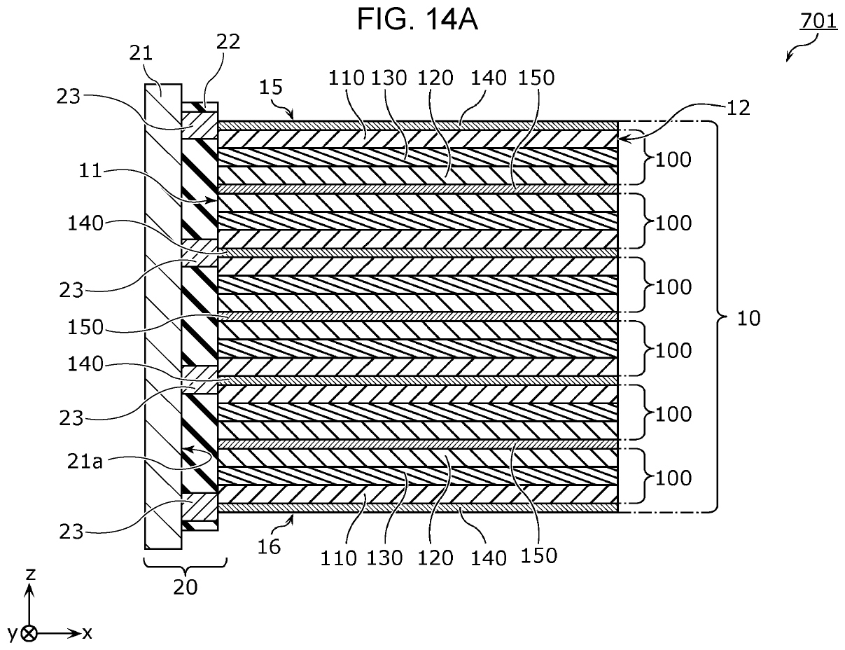

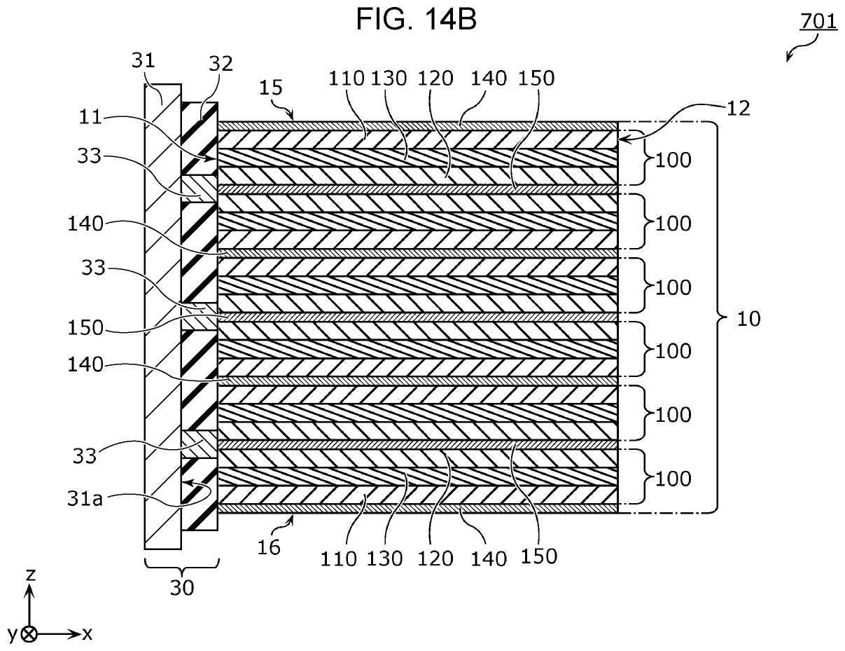

FIG. 13 is a perspective view of a battery 701 according to the present embodiment, illustrating its configuration. FIGS. 14A and 14B are cross-sectional views of the battery 701 according to the present embodiment. FIG. 14A is a cross-sectional view taken along line XIVA-XIVA in FIG. 13, in other words, FIG. 14A illustrates a cross section intersecting a first region of the side surface 11. FIG. 14B is a cross-sectional view taken along line XIVB-XIVB in FIG. 13, in other words, FIG. 14B illustrates a cross section intersecting a second region of the side surface 11.

As illustrated in FIGS. 13, 14A, and 14B, the battery 701 has an electrode connection member 20 and a counter-electrode connection member 30 connected to the same side surface 11. In other words, the side surface 11 includes the first region to which the electrode connection member 20 is connected and the second region to which the counter-electrode connection member 30 is connected. The first region and the second region are regions different from each other and do not overlap each other. The electrode connection member 20 and the counter-electrode connection member 30 are away from each other on the side surface 11.

Since the battery 701 according to the present embodiment enables the electrode connection member and the counter-electrode connection member to be in contact with and electrically connected to the side surface 11 of the power-generation element 10 to extend the electrodes, it is possible to increase the capacity density of the battery 701. In addition, since the electrode connection member 20 and the counter-electrode connection member 30 are gathered and placed on one side surface 11, the other side surfaces 12, 13, and 14 can be flat. This configuration enables the volume of portions not contributing to charging and discharging to be small, improving the effective volume of the battery 701. In addition, this configuration increases the case of mounting, for example, when the battery 701 is mounted on a substrate, and the degree of freedom in design, thereby increasing the degree of freedom in placing the battery 701 in electric or electronic devices.

Note that in the present embodiment, instead of the electrode connection member 20 and the counter-electrode connection member 30, the electrode connection member 220, 320, 420, or 520 and the counter-electrode connection member 230, 330, or 430 may be connected to the same side surface.

### Embodiment 10

Next, the configuration of a battery according to Embodiment 10 will be described. Embodiment 10 differs from Embodiment 9 in that a metal layer for electrodes and a metal layer for counter electrodes are formed on a common insulating layer. The following description focuses on the differences from Embodiment 9, and description of common points is omitted or simplified.

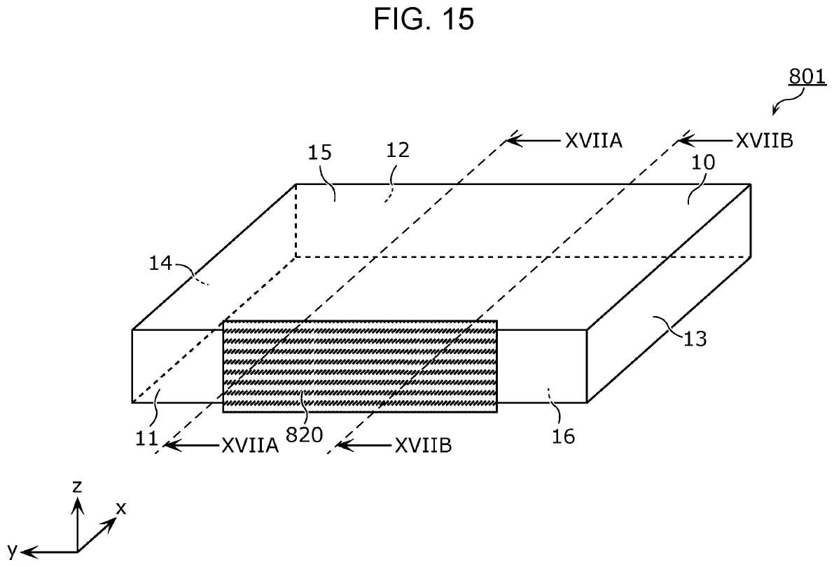

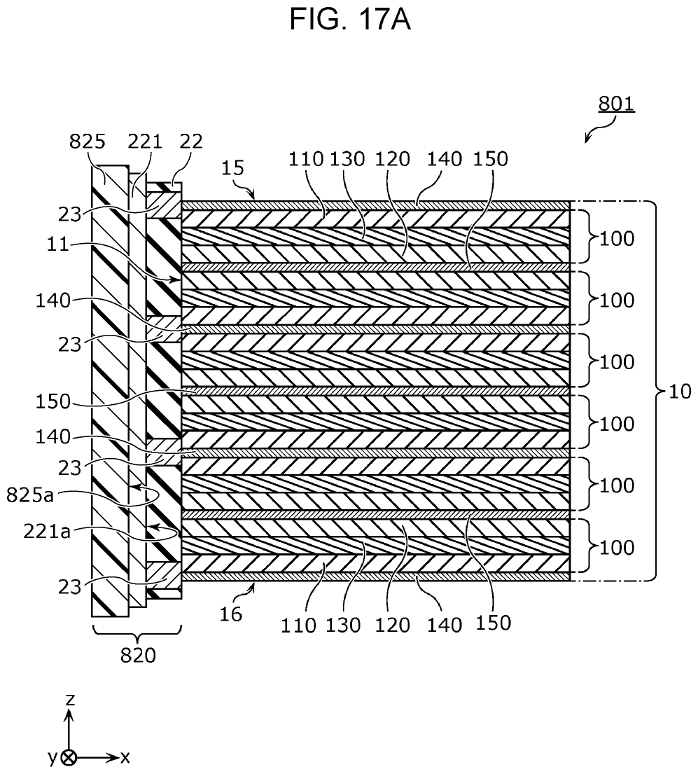

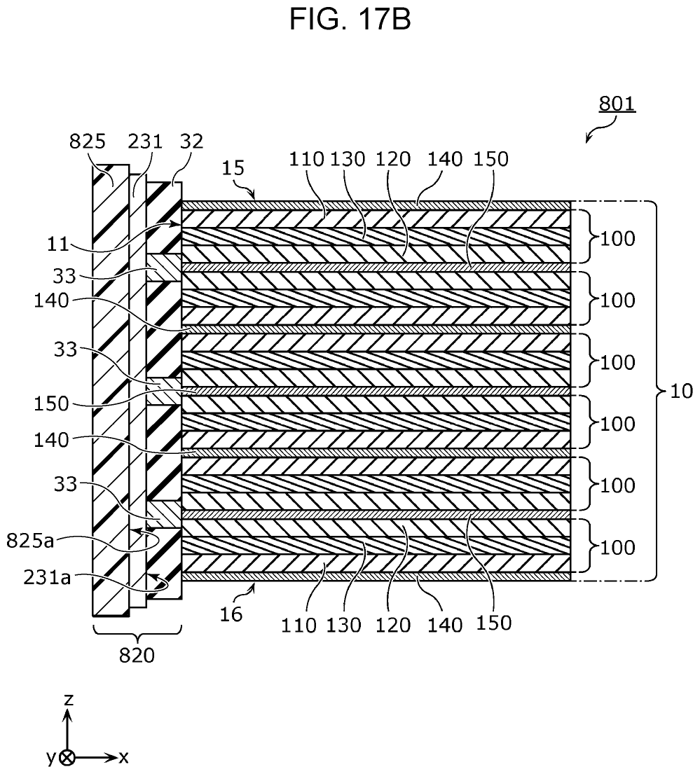

FIG. 15 is a perspective view of a battery 801 according to the present embodiment, illustrating its configuration. FIG. 16 is a side view of a connection member 820 of the battery 801 according to the present embodiment. FIGS. 17A and 17B are cross-sectional views of the battery 801 according to the present embodiment. FIG. 17A is a cross-sectional view taken along line XVIIA-XVIIA in FIGS. 15 and 16, in other words, FIG. 17A illustrates a cross section intersecting a first region of the side surface 11. FIG. 17B is a cross-sectional view taken along line XVIIB-XVIIB in FIGS. 15 and 16, in other words, FIG. 17B illustrates a cross section intersecting a second region of the side surface 11.

As illustrated in FIGS. 15, 16, 17A, and 17B, the battery 801 includes a power-generation element 10 and a connection member 820. The power-generation element 10 is the same as that in Embodiment 9.

The connection member 820 is an example of a first connection member and has functions of both an electrode connection member and a counter-electrode connection member. Specifically, as illustrated in FIGS. 16, 17A, and 17B, the connection member 820 includes a resin film 825, a metal layer 221, an insulating layer 22, conductive vias 23, a metal layer 231, an insulating layer 32, and conductive vias 33. The insulating layer 22, the conductive vias 23, the insulating layer 32, and the conductive vias 33 are the same as those in Embodiment 9. In FIG. 16, illustration of the insulating layers 22 and 32 is omitted.

The resin film 825 is an example of a third insulating layer and has a surface 825a. The surface 825a is an example of a third surface and faces the side surface 11 of the power-generation element 10. The resin film 825 serves as a support member for the metal layers 221 and 231. The metal layer 221 is in contact with the first region of the surface 825a of the resin film 825. The metal layer 231 is in contact with the second region of the surface 825a of the resin film 825. As illustrated in FIG. 16, the metal layer 221 and the metal layer 231 are a specified distance away from each other so as not to make contact with each other.

The method of manufacturing the battery 801 according to the present embodiment is the same as or similar to the method of manufacturing the battery 201 according to Embodiment 3. Metal layers 221 and 231 are formed on one resin film 825. Then, after insulating layers 22 and 32 are formed, conductive vias 23 and 33 are formed. Lastly, a connection member 820 thus formed is connected to the side surface 11 of a power-generation element 10.

As mentioned above, the metal layers 221 and 231 can be formed in one step. In addition, the insulating layers 22 and 32 can be formed in one step, and the conductive vias 23 and 33 can be formed in one step. In other words, an electrode connection member and a counter-electrode connection member can be formed as one connection member 820. Unlike the case in which an electrode connection member and a counter-electrode connection member are connected in separate steps, this configuration only needs one connection step. As described above, the present embodiment simplifies the manufacturing steps.

Note that the number of metal layers formed on the resin film 825 is not limited to two, and three or more metal layers may be formed depending on the configuration.

The insulating layers 22 and 32 may be one continuous insulating layer having a unitary structure. In other words, the insulating layer 22 and the insulating layer 32 need not be separate and may be in contact with each other.

### OTHER EMBODIMENTS

Although the battery and the methods of manufacturing the battery according to the present disclosure have been described with reference to the embodiments, the present disclosure is not limited to these embodiments. Configurations made by modifying the embodiments in various manners that those skilled in the art can come up with and other configurations made by combining constituents in different embodiments are included in the scope of the present disclosure unless they depart from the spirit of the present disclosure.

For example, although the embodiments are based on examples in which a counter-electrode connection member 30 is connected to the side surface 11 or 12, the present disclosure is not limited to these configurations. A counter-electrode connection member 30 may be connected to the side surface 13 or 14. The number of electrode connection members 20 and the number of counter-electrode connection members 30 may also be two. For example, two electrode connection members 20 may be provided on the side surfaces 11 and 13, and two counter-electrode connection members 30 may be provided on the side surfaces 12 and 14. Alternatively, two electrode connection members 20 may be provided on the side surfaces 11 and 12, and two counter-electrode connection members 30 may be provided on the side surfaces 13 and 14.

For example, each of the side surfaces 11, 12, 13, and 14 may be inclined relative to the main surface 15 or 16. Each of the side surfaces 11, 12, 13, and 14 may be curved so as to protrude or be recessed or may include a plurality of flat surfaces having different inclination angles. For example, on the side surfaces 11, 12, 13, and 14, the end surfaces of the electrode layers 110, the counter-electrode layers 120, and the solid electrolyte layers 130 need not be flush with one another and may have protrusions and recesses.

In addition, for example, the number of battery cells 100 included in the power-generation element 10 may be two. In the case in which only two battery cells 100 are laminated such that the electrode layers 110 of the two battery cells 100 face each other, the number of electrode current collector layers 140 may be one. In the case in which only two battery cells 100 are laminated such that the counter-electrode layers 120 of the two battery cells 100 face each other, the number of counter-electrode current collector layers 150 may be one. As mentioned above, the number of electrode current collector layers 140 or counter-electrode current collector layers 150 included in the power-generation element 10 may be one. A configuration in which the power-generation element 10 does not include the electrode current collector layer 140 or the counter-electrode current collector layer 150 is possible.

For example, the number of battery cells 100 included in the power-generation element 10 may be either an even or odd number. In the case in which the number of battery cells 100 is an odd number, the polarities of the current collector layers located in the uppermost and lowermost layers are different. In this case, for example, the electrode connection member 20 can be connected to the main surface of the electrode current collector layer 140 in the uppermost layer, and the counter-electrode connection member 30 can be connected to the main surface of the counter-electrode current collector layer 150 in the lowermost layer.

For example, although the description of each embodiment is based on the battery in which the electrode connection member and the counter-electrode connection member have the same configuration or similar configurations, the present disclosure is not limited to these. For example, the battery may include one or more of the electrode connection members 20, 220, 320, 420, and 520 and one or more of the counter-electrode connection members 30, 230, 330, and 430.

For example, a configuration based on the battery according to one of the embodiments but without one of the electrode connection member and the counter-electrode connection member is possible. For example, a configuration in which a battery includes an electrode connection member and includes conductive lead parts for electrically connecting a plurality of counter-electrode layers 120 instead of a counter-electrode connection member is possible. Even in this case, the volume of the electrode extension portions is smaller than in the case in which lead parts are used in both the electrode and counter-electrode extension portions, and this improves the capacity density of the battery.

As for the aforementioned embodiments, various kinds of modification, replacement, addition, and omission can be made within the scope of the claims and the equivalents thereof.

The present disclosure can be used, for example, for the batteries of electronic devices, electric appliances and devices, electric vehicles, and the like.

What is claimed is:

1. A battery comprising:
a power-generation element including a plurality of laminated battery cells connected electrically in parallel, each battery cell including an electrode layer, a counter-electrode layer, and a solid electrolyte layer; and
a first connection member connected to a side surface of the power-generation element, wherein
the first connection member includes:
a first metal layer having a first surface facing the side surface,
a first insulating layer located on the first surface, and
one or more first conductive vias passing through the first insulating layer and electrically connecting the first metal layer and the electrode layers.

2. The battery according to claim 1, further comprising
a second connection member connected to the side surface, wherein
the second connection member includes
a second metal layer having a second surface facing the side surface,
a second insulating layer located on the second surface, and
one or more second conductive vias passing through the second insulating layer and electrically connecting the second metal layer and the counter-electrode layers.

3. The battery according to claim 2, wherein
the side surface includes a first side surface and a second side surface different from the first side surface,
the first connection member is connected to the first side surface,
the first surface faces the first side surface,
the second connection member is connected to the second side surface, and
the second surface faces the second side surface.

4. The battery according to claim 3, wherein
the first side surface and the second side surface are flat.

5. The battery according to claim 1, wherein
the first connection member further includes
a second metal layer having a second surface facing the side surface and located on the first insulating layer so as to be aligned with the first metal layer,
one or more second conductive vias passing through the first insulating layer and electrically connecting the second metal layer and the counter-electrode layers, and
a third insulating layer having a third surface,
a surface of the first metal layer opposite to the first surface is in contact with the third surface, and
a surface of the second metal layer opposite to the second surface is in contact with the third surface.

6. The battery according to claim 1, wherein
the first connection member further includes a third insulating layer in contact with a surface of the first metal layer opposite to the first surface.

7. The battery according to claim 1, wherein
the first metal layer is a metal foil.

8. The battery according to claim 1, further comprising
one or more conductive pads located on the side surface and between the electrode layers and the one or more first conductive vias.

9. The battery according to claim 8, wherein
the pads contain a resin and conductive particles dispersed in the resin.

10. The battery according to claim 1, wherein
the first metal layer is connected to a main surface of the power-generation element.

11. The battery according to claim 1, wherein
the first metal layer extends in a direction away from the side surface.

12. The battery according to claim 11, further comprising
an outer case containing the power-generation element, wherein
the first metal layer extends to an outside of the outer case.

13. The battery according to claim 1, wherein
the one or more first conductive vias contain a resin and conductive particles dispersed in the resin.

14. A method of manufacturing a battery, comprising
connecting a connection member to a side surface of a power-generation element including a plurality of laminated battery cells connected electrically in parallel, each battery cell including an electrode layer, a counter-electrode layer, and a solid electrolyte layer, wherein
the connection member includes
a first insulating layer and
one or more first conductive vias passing through the first insulating layer, and
in the connecting the connection member, the one or more first conductive vias and the electrode layers are electrically connected such that a first surface of a first metal layer faces the side surface, and that the first insulating layer is located between the side surface and the first surface.

15. The method of manufacturing a battery according to claim 14, further comprising:
forming the first insulating layer on the first surface; and
forming the one or more first conductive vias such that the one or more first conductive vias are in contact with the first metal layer.

16. The method of manufacturing a battery according to claim 14, further comprising:
forming the first insulating layer; and
forming the one or more first conductive vias, wherein
in the connecting the connection member, the first insulating layer in which the one or more first conductive vias are formed is placed between the side surface and the first metal layer so as to be in contact with the side surface and the first metal layer, and the one or more first conductive vias are electrically connected to the electrode layers.

17. The method of manufacturing a battery according to claim 14, further comprising
forming the first metal layer on a main surface of a third insulating layer.

18. The method of manufacturing a battery according to claim 17, further comprising:
forming a second metal layer on the main surface of the third insulating layer at a position away from the first metal layer; and
forming one or more second conductive vias passing through the first insulating layer and being in contact with the second metal layer, wherein
in the connecting the connection member, in addition, the one or more second conductive vias are electrically connected to the counter-electrode layers.

19. The method of manufacturing a battery according to claim 14, further comprising
forming one or more conductive pads connected to the electrode layers, on the side surface of the power-generation element, wherein
in the connecting the connection member, the one or more first conductive vias are brought into contact with the one or more pads.

20. The method of manufacturing a battery according to claim 14, wherein
in the connecting the connection member, at least part of the first metal layer protrudes outward relative to a main surface of the power-generation element, and
the method of manufacturing a battery further comprises bending part of the first metal layer protruding outward relative to the main surface of the power-generation element to bring the first metal layer into contact with the main surface of the power-generation element.
